(19) United States
(12) Patent Application Publication
(10) Pub. No.: US 2026/0125080 A1
(43) Pub. Date: May 7, 2026

(54) METHODS AND ELECTRONIC DEVICES FOR CONTROLLING OPERATION OF A SELF-DRIVING CAR

(71) Applicant: Y.E. Hub Armenia LLC, Yerevan (AM)

(72) Inventor: Aleksey SOLOVYEV, Moscow (RU)

(21) Appl. No.: 19/353,587

(22) Filed: Oct. 8, 2025

(30) Foreign Application Priority Data
Nov. 1, 2024 (RU) 2024132913

(51) Int. Cl. B60W 60/00; B60W 30/09; B60W 30/095; B60W 30/14; G01S 17/89; G06V 10/80; G06V 10/82

(52) U.S. Cl. CPC B60W 60/0015; B60W 30/09; B60W 30/0956; B60W 30/146; G01S 17/89; G06V 10/803; G06V 10/82; B60W 2420/408; B60W 2556/35; B60W 2556/40

(57) ABSTRACT

Methods and electronic devices for controlling operation of a self-driving car (SDC) are disclosed. The method includes receiving sensor data, generating a map of the environment using the sensor data, and generating a grid structure with a plurality of cells corresponding to respective portions of the map. A given cell is associated with a probability value indicative of a probability that an object is present in the respective portion of the map. The method includes, in response to the probability value being above a detection threshold: generating a bounding shape covering the given cell. The method includes, in response to the probability value being between the detection threshold and a second threshold: determining that an undetected object is potentially present. The method includes, in response to the determining that the undetected object is potentially present: triggering the SDC to perform a remedial action.

### CROSS-REFERENCE

The present application claims priority to Russian Patent Application No. 2024132913, entitled “Methods and Electronic Devices for Controlling Operation of a Self-Driving Car”, filed Nov. 1, 2024, the entirety of which is incorporated herein by reference.

### TECHNICAL FIELD

The present technology relates generally to autonomous driving, and more particularly, to methods and electronic devices for controlling operation of a Self-Driving Car (SDC).

### BACKGROUND

Autonomous driving is a technology that enables a vehicle to drive itself without human (or with little) human intervention by using various sensors, computer systems, and algorithms. For example, some sensors used for autonomous driving include inter alia cameras, lidars, radars, and GPS.

Cameras are optical devices that capture images of the surrounding environment. They can provide visual information such as color, texture, shape, and motion of the objects in the scene. Cameras can also recognize road signs, traffic lights, and lane markings. A lidar is a sensor that emits laser beams and measures the time it takes for them to bounce back from the objects in the environment. Lidars can create a 3D point cloud that represents the shape, size, and location of the objects in the scene. Lidars can also measure the distance and velocity of the objects. A radar is a sensor that emits radio waves and measures the time it takes for them to bounce back from the objects in the environment. GPS is a system that uses satellites to determine the geographic location and altitude of the vehicle. GPS can provide coarse information about the position and orientation of the vehicle.

In order to enable autonomous driving, a computer system needs to perform at least three functions: perception, planning, and control. These functions can be implemented via separate computer modules that communicate and cooperate with each other to achieve the desired behavior of the vehicle. Each module can use different sensors, models, and algorithms to perform its respective tasks depending on inter alia the level of autonomy and the requirements of a given scenario.

Designing a system to safely drive a vehicle autonomously is difficult. An autonomous vehicle should be capable of performing as a functional equivalent of an attentive driver who draws upon a perception and action system that has an incredible ability to identify and react to moving and static obstacles in a complex environment, to avoid colliding with other objects or structures along the path of the vehicle. Thus, the ability to detect instances of animate (e.g., objects cars, pedestrians, etc.) and other parts of an environment is necessary for autonomous driving perception systems.

Conventional perception methods rely on cameras or lidar sensors to detect objects in an environment, and a variety of approaches have been developed using Deep Neural Networks (DNNs) to perform object detection. Some DNNs perform “Bird's Eye View” (BEV) object detection. A BEV map is a result of transforming a multi-dimensional representation of the surroundings into a 2D image that shows the scene from a top-down perspective. This can help to reduce the complexity of the data and make it easier to apply computer vision techniques for object detection and localization.

US Patent Publication 2022/0289237 discloses a map-free generic obstacle detection for collision avoidance systems.

### SUMMARY

Developers of the present technology have realized at least some drawbacks with known solutions for object detection in an environment of a Self-Driving Car (SDC).

Generally speaking, an object detection module of a SDC is configured to inter alia locate and classify objects in the environment of the SDC. It can be said that an object is “detected” when the object detection module generates a bounding shape for a portion of a map of the environment. The object detection module may also assign a label/class to the bounding shape indicative of a class of object located in the corresponding portion of the map.

Initially, the object detection module gathers data from a variety of sensors, such as cameras, lidars, and radars, for example, and which is indicative of a vehicle's surroundings. This data may undergo pre-processing to correct distortions and/or remove noise, ensuring that the information is accurate and synchronized across different sensor types. Data from different sensors can be combined or “fused” in a combined representation of the surroundings. This combined representation may include a plurality of features such as edges, shapes, colors, and patterns, for example, and which can be used for distinguishing objects in the environment.

This combined representation including a plurality of features is analyzed by a Neural Network (NN). The NN is configured to generate a grid structure to discretize the combined representation and uses features to assign probabilities to respective cells of the grid structure, indicative of a likelihood of an object being present in a respective cell. The NN is configured to generate a bounding shape about a cluster of cells based on the respective probabilities, thereby outlining the object's location and dimensions. A given cell may be bounded, or not, by a bounding shape depending on inter alia the probability value assigned to the given cell, and a specific bounding technique used by the NN. A variety of bounding techniques may be employed to generate one or more bounding shapes covering one or more clusters of cells of the grid structure using the probability values associated with the respective cells.

In one non-limiting example, the NN may generate one or more bounding shapes covering cells with relatively high probability values, while not generating bounding shapes for cells with relatively low probability values via a comparison against a probability threshold.

It should be noted that, during a given detection cycle, some bounding techniques may be used to evaluate different options or “candidates” for bounding shapes in an attempt to detect object boundaries. These bounding techniques are then used to generate one or more “target” bounding shapes for that given detection cycle. The target bounding shapes correspond to the best candidates, based on one or more optimization objectives, and are indicative of boundaries of one or more detected objects in the environment to be used for further path planning and control of the SDC.

Developers of the present technology have realized that conventional object detection modules may not be able to detect some objects in the surroundings, resulting in one or more objects remaining undetected. It should be noted that performing path planning and control of the SDC based on detected objects, while some undetected objects are also present in the surroundings, may be detrimental to the safety of SDC passengers and other actors in the surroundings.

Developers identified a technical challenge with detection of objects located in blind zones—that is, zones that sensors cannot sufficiently cover due to their positioning, range limitations, and/or physical obstructions. Objects in these zones may be partially visible or completely obstructed, leading to incomplete data for feature extraction and recognition processes. Due to limited sensor data about blind zones, cells in the grid structure corresponding to an object located in a blind zone may be assigned with probability values that are comparatively lower to probability values of cells corresponding to an object that is not located in a blind zone. The object detection module may thus not generate a bounding shape for cells corresponding to the object located in the blind zone due to their probability values computed based on limited sensor data.

Developers identified a technical challenge with at least some conventional bounding techniques. Conventional bounding techniques may determine whether or not to bound a given cell with a bounding shape based on inter alia one or more optimization objectives. Thus, some cells may not be bounded by a bounding shape due to, for example, an optimization process for increasing accuracy of one or more boundaries of one or more bounding shapes.

Irrespective of whether a given cell (or group of cells) has not been bounded due to its probability value being impacted by limited sensor data, or due to one or more optimization objectives of a given bounding technique, the given cell (or group of cells) may nevertheless have a probability value that is high enough to be considered as a “knowledge artifact” about the surroundings of the SDC. Such cells may be referred to as “mid-tier” cells that, although not being bounded by a bounding shape, may still carry some information about potential presence of other, undetected, objects in the surroundings of the SDC. In at least some embodiments of the present technology, there is provided processors and methods for identifying and making use of “mid-tier” cells for controlling operation of the SDC, even though they have not been bounded and/or do not correspond to any detected object.

Developers of the present technology have realized one or more technical advantage(s) of methods and devices disclosed herein. At least some embodiments of the present technology may allow to ameliorate object detection capabilities of a SDC, resulting in the SDC being able to consider one or more additional objects during path planning and control of the SDC and which would otherwise not be considered. It should be noted that performing path planning and control of the SDC based on detected objects and information generated using at least some embodiments of the present technology may increase the safety of SDC passengers and other actors in the surroundings.

It should be noted that a performance metric used in the context of the present technology may be an average number of collisions between a SDC and moving test objects (pedestrians). It is contemplated that two pools of test data may be employed for evaluating the performance metric. A first pool of test data may comprise datasets for 50 scenes in which collisions occurred between a SDC and moving test objects. Developers have realized that employing at least some methods and devices described herein may allow to reduce the performance metric value by 30% in the first pool of test data. A second pool of test data may comprise datasets for a comparatively larger number of scenes, such as 1000 scenes, for example, in which a variety of scenarios involving a SDC and moving test objects occurred. The variety of scenarios may include collisions between a SDC and moving test objects and additional dangerous scenarios involving a SDC and moving test objects. Developers have realized that employing at least some methods and devices described herein may allow to reduce the performance metric value by 20% in the second pool of test data.

In at least one aspect of the present technology, there is provided a method of controlling operation of a self-driving car (SDC), the method including: receiving sensor data about an environment of the SDC; generating, using a Neural Network (NN), a map of the environment using the sensor data; generating, using the NN, a grid structure with a plurality of cells corresponding to respective portions of the map, a given cell from the plurality of cells being associated with a probability value indicative of a probability that an object is present in the respective portion of the map; in response to the probability value being above a detection threshold: generating a bounding shape covering the given cell, the bounding shape being indicative of that a detected object is present in the respective portion of the map; in response to the probability value being between the detection threshold and a second threshold, the second threshold being inferior to the detection threshold: determining that an undetected object is potentially present in the respective portion of the map; and in response to the determining that the undetected object is potentially present in the respective portion of the map: triggering the SDC to perform a remedial action.

In some embodiments of the method, the sensor data comprises first sensor data from a first sensor, and second sensor data from a second sensor.

In some embodiments of the method, first sensor data is a point cloud and the first sensor is a LIDAR sensor.

In some embodiments of the method, the method further comprises generating fused sensor data by combining the first sensor data and the second sensor data, and wherein the generating the map of the environment comprises generating the map of the environment using the fused sensor data.

In some embodiments of the method, the map of the environment is a Bird Eye View (BEV) map of the environment.

In some embodiments of the method, the bounding shape is a bounding box.

In some embodiments of the method, wherein the remedial action is a reduction of speed of the SDC.

In some embodiments of the method, the triggering the SDC to perform the remedial action is executed independently from one or more path planning operations.

In some embodiments of the method, the generating the bounding shape comprises executing a Non-Maximum Suppression (NMS) algorithm onto a plurality of candidate bounding shapes.

In another aspect of the present technology, there is provided a method of controlling operation of a self-driving car (SDC), the method including: receiving sensor data about an environment of the SDC; generating, using a Neural Network, a map of the environment using the sensor data; generating, using the NN, a grid structure with a plurality of cells corresponding to respective portions of the map, the plurality of cells being associated with respective probability values indicative of a probability that an object is present in the respective portions of the map; executing a two-stage object detection process onto the grid structure, including: during a first stage: generating a bounding shape covering a first cell from the plurality of cells based on a first probability value of the first cell, the bounding shape being indicative of that a detected object is present in a first portion of the map corresponding to the first cell, the first cell being a bounded cell; during a second stage: determining that an undetected object is potentially present in a second portion of the map corresponding to a non-bounded cell based on a second probability value of the non-bounded cell; triggering control of the SDC based on the presence of the detected object in the first portion and the potential presence of the undetected object in the second portion.

In another aspect of the present technology, there is provided an electronic device for controlling operation of a self-driving car (SDC), the electronic device being configured to: receive sensor data about an environment of the SDC; generate, using a Neural Network (NN), a map of the environment using the sensor data; generate, using the NN, a grid structure with a plurality of cells corresponding to respective portions of the map, a given cell from the plurality of cells being associated with a probability value indicative of a probability that an object is present in the respective portion of the map; in response to the probability value being above a detection threshold: generate a bounding shape covering the given cell, the bounding shape being indicative of that a detected object is present in the respective portion of the map; in response to the probability value being between the detection threshold and a second threshold, the second threshold being inferior to the detection threshold: determine that an undetected object is potentially present in the respective portion of the map; and in response to determining that the undetected object is potentially present in the respective portion of the map: trigger the SDC to perform a remedial action.

In some embodiments of the electronic device, wherein the sensor data comprises first sensor data from a first sensor, and second sensor data from a second sensor.

In some embodiments of the electronic device, the first sensor data is a point cloud and the first sensor is a LIDAR sensor.

In some embodiments of the electronic device, the electronic device is further configured to generate fused sensor data by combining the first sensor data and the second sensor data, and wherein to generating the map of the environment comprises the electronic device configured to generate the map of the environment using the fused sensor data.

In some embodiments of the electronic device, the map of the environment is a Bird Eye View (BEV) map of the environment.

In some embodiments of the electronic device, the bounding shape is a bounding box.

In some embodiments of the electronic device, the remedial action is a reduction of speed of the SDC.

In some embodiments of the electronic device, to trigger the SDC to perform the remedial action comprises the electronic device to perform the remedial action independently from one or more path planning operations.

In some embodiments of the electronic device, to generating the bounding shape comprises the electronic device configured to execute a Non-Maximum Suppression (NMS) algorithm onto a plurality of candidate bounding shapes.

In some embodiments of the electronic device, the electronic device is a local electronic device of the SDC.

In the context of the present specification, the term “light source” broadly refers to any device configured to emit radiation such as a radiation signal in the form of a beam, for example, without limitation, a light beam including radiation of one or more respective wavelengths within the electromagnetic spectrum. In one example, the light source can be a “laser source”. Thus, the light source could include a laser such as a solid-state laser, laser diode, a high power laser, or an alternative light source such as, a light emitting diode (LED)-based light source. Some (non-limiting) examples of the laser source include: a Fabry-Perot laser diode, a quantum well laser, a distributed Bragg reflector (DBR) laser, a distributed feedback (DFB) laser, a fiber-laser, or a vertical-cavity surface-emitting laser (VCSEL). In addition, the laser source may emit light beams in differing formats, such as light pulses, continuous wave (CW), quasi-CW, and so on. In some non-limiting examples, the laser source may include a laser diode configured to emit light at a wavelength between about 650 nm and 1150 nm. Alternatively, the light source may include a laser diode configured to emit light beams at a wavelength between about 800 nm and about 1000 nm, between about 850 nm and about 950 nm, between about 1300 nm and about 1600 nm, or in between any other suitable range. Unless indicated otherwise, the term “about” with regard to a numeric value is defined as a variance of up to 10% with respect to the stated value.

In the context of the present specification, an “output beam” may also be referred to as a radiation beam, such as a light beam, that is generated by the radiation source and is directed downrange towards a region of interest. The output beam may have one or more parameters such as: beam duration, beam angular dispersion, wavelength, instantaneous power, photon density at different distances from light source, average power, beam power intensity, beam width, beam repetition rate, beam sequence, pulse duty cycle, wavelength, or phase etc. The output beam may be unpolarized or randomly polarized, may have no specific or fixed polarization (e.g., the polarization may vary with time), or may have a particular polarization (e.g., linear polarization, elliptical polarization, or circular polarization).

In the context of the present specification, an “input beam” is radiation or light entering the system, generally after having been reflected from one or more objects in the ROI. The “input beam” may also be referred to as a radiation beam or light beam. By reflected is meant that at least a portion of the output beam incident on one or more objects in the ROI, bounces off the one or more objects. The input beam may have one or more parameters such as: time-of-flight (i.e., time from emission until detection), instantaneous power (e.g., power signature), average power across entire return pulse, and photon distribution/signal over return pulse period etc. Depending on the particular usage, some radiation or light collected in the input beam could be from sources other than a reflected output beam. For instance, at least some portion of the input beam could include light-noise from the surrounding environment (including scattered sunlight) or other light sources exterior to the present system.

In the context of the present specification, the term “surroundings” or “environment” of a given vehicle refers to an area or a volume around the given vehicle including a portion of a current environment thereof accessible for scanning using one or more sensors mounted on the given vehicle, for example, for generating a 3D map of the such surroundings or detecting objects therein.

In the context of the present specification, a “Region of Interest” may broadly include a portion of the observable environment of a LIDAR system in which the one or more objects may be detected. It is noted that the region of interest of the LIDAR system may be affected by various conditions such as but not limited to: an orientation of the LIDAR system (e.g. direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The ROI of LIDAR system may be defined, for example, by a plane angle or a solid angle. In one example, the ROI may also be defined within a certain distance range (e.g. up to 200 m or so).

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system configurable for implementing certain non-limiting embodiments of the present technology.

FIG. 2 depicts a schematic diagram of a networked computing environment being suitable for use with certain non-limiting embodiments of the present technology.

FIG. 3 depicts a schematic diagram of an example LIDAR system implemented in accordance with certain non-limiting embodiments of the present technology.

FIG. 4 depicts a schematic diagram of a processing pipeline executed by an electronic device of FIG. 2, in accordance with some embodiments of the present technology.

FIG. 5 there is depicted an example of an actual BEV representation of the surroundings of the vehicle, in accordance with some embodiments of the present technology.

FIG. 6 depicts a grid structure generated by the electronic device for the BEV map.

FIG. 7 shows the grid structure with a plurality of probability values generated by the electronic device.

FIG. 8 shows a bounding box generated by the electronic device for a first cluster of cells and a non-bounded region for a second cluster of cells.

FIG. 9 shows a representation of a processing pipeline executed by the electronic device, in accordance with some embodiments of the present technology.

FIG. 10 is a schematic flowchart of a method executable in accordance with certain non-limiting embodiments of the present technology.

FIG. 11 is a schematic flowchart of a method executable in accordance with certain non-limiting embodiments of the present technology.

FIG. 12 depicts an example of BEV map generated by the electronic device, in accordance with some embodiments of the present technology.

FIG. 13 depicts a schematic illustration of a neural architecture employed by a perception module, in one non-limiting embodiment of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

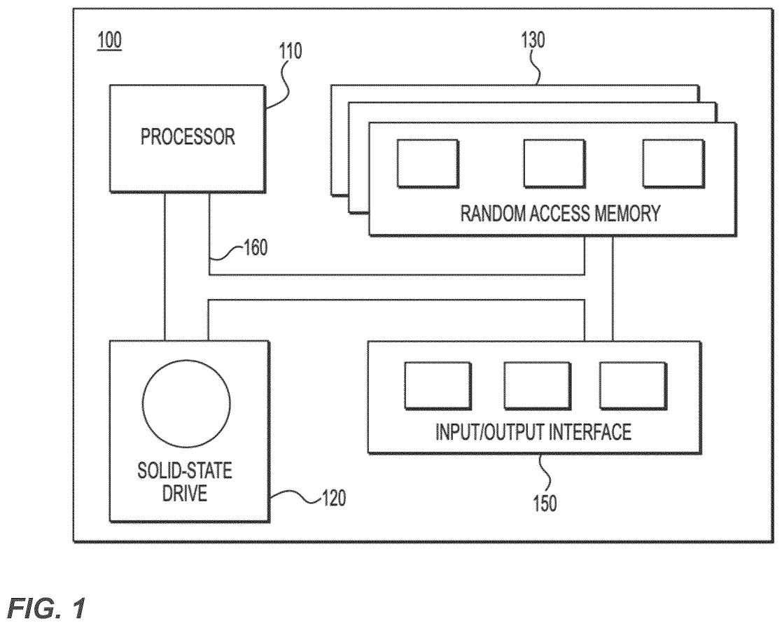

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an laaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

### Networked Computing Environment

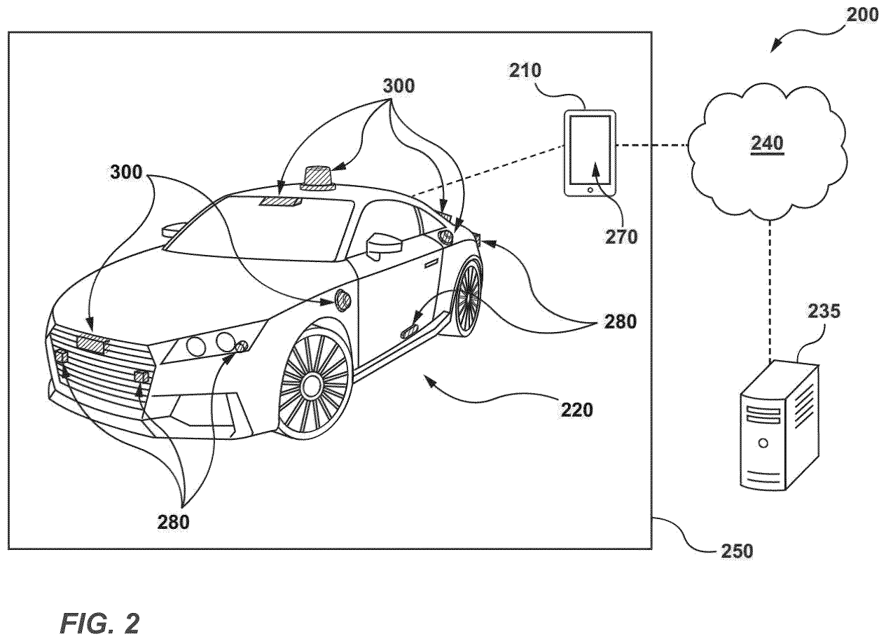

With reference to FIG. 2, there is depicted a networked computing environment 200 suitable for use with some non-limiting embodiments of the present technology. The networked computing environment 200 includes an electronic device 210 associated with a vehicle 220 and/or associated with a user (not depicted) who is associated with the vehicle 220 (such as an operator of the vehicle 220). The networked computing environment 200 also includes a server 235 in communication with the electronic device 210 via a communication network 240 (e.g. the Internet or the like, as will be described in greater detail herein below).

In some non-limiting embodiments of the present technology, the networked computing environment 200 could include a GPS satellite (not depicted) transmitting and/or receiving a GPS signal to/from the electronic device 210. It will be understood that the present technology is not limited to GPS and may employ a positioning technology other than GPS. It should be noted that the GPS satellite can be omitted altogether.

The vehicle 220, to which the electronic device 210 is associated, could be any transportation vehicle, for leisure or otherwise, such as a private or commercial car, truck, motorbike or the like. Although the vehicle 220 is depicted as being a land vehicle, this may not be the case in each and every non-limiting embodiment of the present technology. For example, in certain non-limiting embodiments of the present technology, the vehicle 220 may be a watercraft, such as a boat, or an aircraft, such as a flying drone.

The vehicle 220 may be user operated or a driver-less vehicle. In some non-limiting embodiments of the present technology, it is contemplated that the vehicle 220 could be implemented as a Self-Driving Car (SDC). It should be noted that specific parameters of the vehicle 220 are not limiting, these specific parameters including for example: vehicle manufacturer, vehicle model, vehicle year of manufacture, vehicle weight, vehicle dimensions, vehicle weight distribution, vehicle surface area, vehicle height, drive train type (e.g. 2× or 4×), tire type, brake system, fuel system, mileage, vehicle identification number, and engine size.

According to the present technology, the implementation of the electronic device 210 is not particularly limited. For example, the electronic device 210 could be implemented as a vehicle engine control unit, a vehicle CPU, a vehicle navigation device (e.g. TomTom™, Garmin™), a tablet, a personal computer built into the vehicle 220, and the like. Thus, it should be noted that the electronic device 210 may or may not be permanently associated with the vehicle 220. Additionally or alternatively, the electronic device 210 could be implemented in a wireless communication device such as a mobile telephone (e.g. a smart-phone or a radio-phone). In certain embodiments, the electronic device 210 has a display 270.

The electronic device 210 could include some or all of the components of the computer system 100 depicted in FIG. 1, depending on the particular embodiment. In certain embodiments, the electronic device 210 is an on-board computer device and includes the processor 110, the solid-state drive 120 and the memory 130. In other words, the electronic device 210 includes hardware and/or software and/or firmware, or a combination thereof, for processing data as will be described in greater detail below.

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network 240 are for illustration purposes only. A communication link (not separately numbered) is provided between the electronic device 210 and the communication network 240, the implementation of which will depend, inter alia, on how the electronic device 210 is implemented. Merely as an example and not as a limitation, in those non-limiting embodiments of the present technology where the electronic device 210 is implemented as a wireless communication device such as a smartphone or a navigation device, the communication link can be implemented as a wireless communication link. Examples of wireless communication links may include, but are not limited to, a 3G communication network link, a 4G communication network link, and the like. The communication network 240 may also use a wireless connection with the server 235.

In some embodiments of the present technology, the server 235 is implemented as a computer server and could include some or all of the components of the computer system 100 of FIG. 1. In one non-limiting example, the server 235 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 235 is a single server. In alternative non-limiting embodiments of the present technology, the functionality of the server 235 may be distributed and may be implemented via multiple servers (not shown).

In some non-limiting embodiments of the present technology, the processor 110 of the electronic device 210 could be in communication with the server 235 to receive one or more updates. Such updates could include, but are not limited to, software updates, map updates, routes updates, weather updates, and the like. In some non-limiting embodiments of the present technology, the processor 110 can also be configured to transmit to the server 235 certain operational data, such as routes travelled, traffic data, performance data, and the like. Some or all such data transmitted between the vehicle 220 and the server 235 may be encrypted and/or anonymized.

It should be noted that a variety of sensors and systems may be used by the electronic device 210 for gathering information about surroundings 250 of the vehicle 220. As seen in FIG. 2, the vehicle 220 may be equipped with a plurality of sensor systems 280. It should be noted that different sensor systems from the plurality of sensor systems 280 may be used for gathering different types of data regarding the surroundings 250 of the vehicle 220.

In one example, the plurality of sensor systems 280 may include various optical systems including, inter alia, one or more camera-type sensor systems that are mounted to the vehicle 220 and communicatively coupled to the processor 110 of the electronic device 210. Broadly speaking, the one or more camera-type sensor systems may be configured to gather image data about various portions of the surroundings 250 of the vehicle 220. In some cases, the image data provided by the one or more camera-type sensor systems could be used by the electronic device 210 for performing object detection procedures. For example, the electronic device 210 could be configured to feed the image data provided by the one or more camera-type sensor systems to an Object Detection Neural Network (ODNN) that has been trained to localize and classify potential objects in the surroundings 250 of the vehicle 220.

In another example, the plurality of sensor systems 280 could include one or more radar-type sensor systems that are mounted to the vehicle 220 and communicatively coupled to the processor 110. Broadly speaking, the one or more radar-type sensor systems may be configured to make use of radio waves to gather data about various portions of the surroundings 250 of the vehicle 220. For example, the one or more radar-type sensor systems may be configured to gather radar data about potential objects in the surroundings 250 of the vehicle 220, such data potentially being representative of a distance of objects from the radar-type sensor system, orientation of objects, velocity and/or speed of objects, and the like.

It should be noted that the plurality of sensor systems 280 could include additional types of sensor systems to those non-exhaustively described above and without departing from the scope of the present technology.

### LIDAR System

According to the non-limiting embodiments of the present technology and as is illustrated in FIG. 2, the vehicle 220 is equipped with at least one Light Detection and Ranging (LIDAR) system, such as a LIDAR system 300, for gathering information about surroundings 250 of the vehicle 220. While only described herein in the context of being attached to the vehicle 220, it is also contemplated that the LIDAR system 300 could be a stand-alone operation or connected to another system.

Depending on the embodiment, the vehicle 220 could include more or fewer LIDAR systems 300 than illustrated. Depending on the particular embodiment, choice of inclusion of particular ones of the plurality of sensor systems 280 could depend on the particular embodiment of the LIDAR system 300. The LIDAR system 300 could be mounted, or retrofitted, to the vehicle 220 in a variety of locations and/or in a variety of configurations.

For example, depending on the implementation of the vehicle 220 and the LIDAR system 300, the LIDAR system 300 could be mounted on an interior, upper portion of a windshield of the vehicle 220. Nevertheless, as illustrated in FIG. 2, other locations for mounting the LIDAR system 300 are within the scope of the present disclosure, including on a back window, side windows, front hood, rooftop, front grill, front bumper or the side of the vehicle 220. In some cases, the LIDAR system 300 can even be mounted in a dedicated enclosure mounted on the top of the vehicle 220.

In some non-limiting embodiments, such as that of FIG. 2, a given one of the plurality of LIDAR systems 300 is mounted to the rooftop of the vehicle 220 in a rotatable configuration. For example, the LIDAR system 300 mounted to the vehicle 220 in a rotatable configuration could include at least some components that are rotatable 360 degrees about an axis of rotation of the given LIDAR system 300. When mounted in rotatable configurations, the given LIDAR system 300 could gather data about most of the portions of the surroundings 250 of the vehicle 220.

In some non-limiting embodiments of the present technology, such as that of FIG. 2, the LIDAR systems 300 is mounted to the side, or the front grill, for example, in a non-rotatable configuration. For example, the LIDAR system 300 mounted to the vehicle 220 in a non-rotatable configuration could include at least some components that are not rotatable 360 degrees and are configured to gather data about pre-determined portions of the surroundings 250 of the vehicle 220.

Irrespective of the specific location and/or the specific configuration of the LIDAR system 300, it is configured to capture data about the surroundings 250 of the vehicle 220 used, for example, for building a multi-dimensional map of objects in the surroundings 250 of the vehicle 220. Details relating to the configuration of the LIDAR systems 300 to capture the data about the surroundings 250 of the vehicle 220 will now be described.

It should be noted that although in the description provided herein the LIDAR system 300 is implemented as a Time of Flight LIDAR system—and as such, includes respective components suitable for such implementation thereof—other implementations of the LIDAR system 300 are also possible without departing from the scope of the present technology. For example, in certain non-limiting embodiments of the present technology, the LIDAR system 300 may also be implemented as a Frequency-Modulated Continuous Wave (FMCW) LIDAR system according to one or more implementation variants and based on respective components thereof as disclosed in a Russian Patent Application 2020117983 filed Jun. 1, 2020 and entitled “Lidar Detection Methods And Systems”; the content of which is hereby incorporated by reference in its entirety.

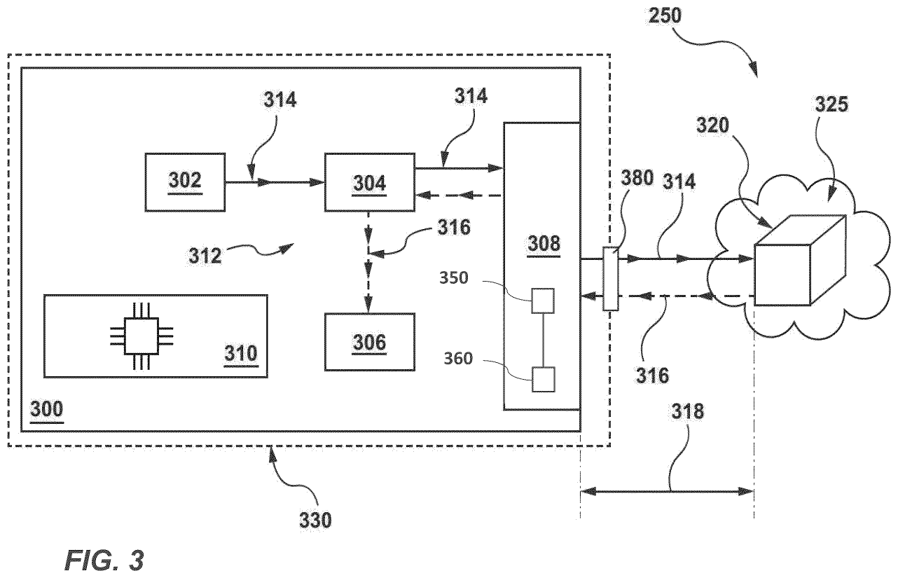

With reference to FIG. 3, there is depicted a schematic diagram of one particular embodiment of the LIDAR system 300 implemented in accordance with certain non-limiting embodiments of the present technology.

Broadly speaking, the LIDAR system 300 includes a variety of internal components including, but not limited to: (i) a light source 302 (also referred to as a “laser source” or a “radiation source”), (ii) a beam splitting element 304, (iii) a scanning unit 308 (also referred to as a “scanner”, and “scanner assembly”), (iv) a detection unit 306 (also referred to herein as a “detection system”, “receiving assembly”, or a “detector”), and (v) a controller 310. It is contemplated that in addition to the components non-exhaustively listed above, the LIDAR system 300 could include a variety of sensors (such as, for example, a temperature sensor, a moisture sensor, etc.) which are omitted from FIG. 3 for sake of clarity.

In certain non-limiting embodiments of the present technology, one or more of the internal components of the LIDAR system 300 are disposed in a common housing 330 as depicted in FIG. 3. In some embodiments of the present technology, the controller 310 could be located outside of the common housing 330 and communicatively connected to the components therein. As it will become apparent from the description herein further below, the housing 330 has a window 380 towards the surroundings of the vehicle 220 for allowing beams of light exiting the housing 330 and entering the housing 330.

Generally speaking, the LIDAR system 300 operates as follows: the light source 302 of the LIDAR system 300 emits pulses of light, forming an output beam 314; the scanning unit 308 scans the output beam 314 through the window 380 across the surroundings 250 of the vehicle 220 for locating/capturing data of a priori unknown objects (such as an object 320) therein, for example, for generating a multi-dimensional map of the surroundings 250 where objects (including the object 320) are represented in a form of one or more data points. The light source 302 and the scanning unit 308 will be described in more detail below.

As certain non-limiting examples, the object 320 may include all or a portion of a person, vehicle, motorcycle, truck, train, bicycle, wheelchair, pushchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects.

Further, let it be assumed that the object 320 is located at a distance 318 from the LIDAR system 300. Once the output beam 314 reaches the object 320, the object 320 generally reflects at least a portion of light from the output beam 314, and some of the reflected light beams may return back towards the LIDAR system 300, to be received in the form of an input beam 316. By reflecting, it is meant that at least a portion of light beam from the output beam 314 bounces off the object 320. A portion of the light beam from the output beam 314 may be absorbed or scattered by the object 320.

Accordingly, the input beam 316 is captured and detected by the LIDAR system 300 via the detection unit 306. In response, the detection unit 306 is then configured to generate one or more representative data signals. For example, the detection unit 306 may generate an output electrical signal (not depicted) that is representative of the input beam 316. The detection unit 306 may also provide the so-generated electrical signal to the controller 310 for further processing. Finally, by measuring a time between emitting the output beam 314 and receiving the input beam 316 the distance 318 to the object 320 is calculated by the controller 310.

As will be described in more detail below, the beam splitting element 304 is utilized for directing the output beam 314 from the light source 302 to the scanning unit 308 and for directing the input beam 316 from the scanning unit to the detection unit 306.

Use and implementations of these components of the LIDAR system 300, in accordance with certain non-limiting embodiments of the present technology, will be described immediately below.

The light source 302 is communicatively coupled to the controller 310 and is configured to emit light having a given operating wavelength. To that end, in certain non-limiting embodiments of the present technology, the light source 302 could include at least one laser pre-configured for operation at the given operating wavelength. The given operating wavelength of the light source 302 may be in the infrared, visible, and/or ultraviolet portions of the electromagnetic spectrum. For example, the light source 302 may include at least one laser with an operating wavelength between about 650 nm and 1150 nm. Alternatively, the light source 302 may include a laser diode configured to emit light at a wavelength between about 800 nm and about 1000 nm, between about 850 nm and about 950 nm, or between about 1300 nm and about 1600 nm. In certain other embodiments, the light source 302 could include a light emitting diode (LED).

With continued reference to FIG. 3, there is further provided the beam splitting element 304 disposed in the housing 330. For example, as previously mentioned, the beam splitting element 304 is configured to direct the output beam 314 from the light source 302 towards the scanning unit 308. The beam splitting element 304 is also arranged and configured to direct the input beam 316 reflected off the object 320 to the detection unit 306 for further processing thereof by the controller 310.

In a specific non-limiting example, the beam splitting element 304 can be implemented as a fiber-optic-based beam splitter component that may be of a type available from OZ Optics Ltd. of 219 Westbrook Rd Ottawa, Ontario KOA 1LO Canada. It should be expressly understood that the beam splitting element 304 can be implemented in any other suitable equipment.

As is schematically depicted in FIG. 3, the LIDAR system 300 forms a plurality of internal beam paths 312 along which the output beam 314 (generated by the light source 302) and the input beam 316 (received from the surroundings 250) propagate. Specifically, light propagates along the internal beam paths 312 as follows: the light from the light source 302 passes through the beam splitting element 304, to the scanning unit 308 and, in turn, the scanning unit 308 directs the output beam 314 outward towards the surroundings 250.

Similarly, the input beam 316 follows the plurality of internal beam paths 312 to the detection unit 306. Specifically, the input beam 316 is directed by the scanning unit 308 into the LIDAR system 300 through the beam splitting element 304, toward the detection unit 306. In some implementations, the LIDAR system 300 could be arranged with beam paths that direct the input beam 316 directly from the surroundings 250 to the detection unit 306 (without the input beam 316 passing through the scanning unit 308).

It should be noted that, in various non-limiting embodiments of the present technology, the plurality of internal beam paths 312 may include a variety of optical components. For example, the LIDAR system 300 may include one or more optical components configured to condition, shape, filter, modify, steer, or direct the output beam 314 and/or the input beam 316. For example, the LIDAR system 300 may include one or more lenses, mirrors, filters (e.g., band pass or interference filters), optical fibers, circulators, beam splitters, polarizers, polarizing beam splitters, wave plates (e.g., half-wave or quarter-wave plates), diffractive elements, microelectromechanical (MEM) elements, collimating elements, or holographic elements.

Generally speaking, the scanning unit 308 steers the output beam 314 in one or more directions downrange towards the surroundings 250. The scanning unit 308 is communicatively coupled to the controller 310. As such, the controller 310 is configured to control the scanning unit 308 so as to guide the output beam 314 in a desired direction downrange and/or along a predetermined scan pattern. Broadly speaking, in the context of the present specification “scan pattern” may refer to a pattern or path along which the output beam 314 is directed by the scanning unit 308 during operation.

In certain non-limiting embodiments of the present technology, the controller 310 is configured to cause the scanning unit 308 to scan the output beam 314 over a variety of horizontal angular ranges and/or vertical angular ranges; the total angular extent over which the scanning unit 308 scans the output beam 314 is sometimes referred to as the field of view (FOV). It is contemplated that the particular arrangement, orientation, and/or angular ranges could depend on the particular implementation of the LIDAR system 300. The field of view generally includes a plurality of regions of interest (ROIs), defined as portions of the FOV which may contain, for instance, objects of interest. In some implementations, the scanning unit 308 can be configured to further investigate a selected region of interest (ROI) 325. The ROI 325 of the LIDAR system 300 may refer to an area, a volume, a region, an angular range, and/or portion(s) of the surroundings 250 about which the LIDAR system 300 may be configured to scan and/or can capture data.

It should be noted that a location of the object 320 in the surroundings 250 of the vehicle 220 may be overlapped, encompassed, or enclosed at least partially within the ROI 325 of the LIDAR system 300.

According to certain non-limiting embodiments of the present technology, the scanning unit 308 may be configured to scan the output beam 314 horizontally and/or vertically, and as such, the ROI 325 of the LIDAR system 300 may have a horizontal direction and a vertical direction. For example, the ROI 325 may be defined by 45 degrees in the horizontal direction, and by 45 degrees in the vertical direction. In some implementations, different scanning axes could have different orientations.

The scanning unit 308 includes a first reflective component 350 and a second reflective component 360. The first reflective component 350 is configured to redirect the output beam 314 from the beam splitting component towards the second reflective component 350 while spreading the output beam along a first axis. The second reflective component 360 is configured to redirect the output beam 314 from the first reflective component 350 towards the surroundings 250 (through the window 380 of the housing 330) while spreading the output beam along a second axis. The second axis can be perpendicular and/or orthogonal to the first axis. As such, so-redirecting and so-spreading the output beam 314 by the combination of the first reflective component 350 and the second reflective component 360 allows to scan the surroundings 250 of the vehicle 220 along at least two perpendicular/orthogonal axes.

Returning to the description of FIG. 3, the LIDAR system 300 may thus make use of the predetermined scan pattern to generate a point cloud substantially covering the ROI 325 of the LIDAR system 300. Again, this point cloud of the LIDAR system 300 may be used to render a multi-dimensional map of objects in the surroundings 250 of the vehicle 220.

According to certain non-limiting embodiments of the present technology, the detection unit 306 is communicatively coupled to the controller 310 and may be implemented in a variety of ways. According to the present technology, the detection unit 306 includes a photodetector, but could include (but is not limited to) a photoreceiver, optical receiver, optical sensor, detector, optical detector, optical fibers, and the like. As mentioned above, in some non-limiting embodiments of the present technology, the detection unit 306 may be configured to acquire or detects at least a portion of the input beam 316 and produces an electrical signal that corresponds to the input beam 316. For example, if the input beam 316 includes an optical pulse, the detection unit 306 may produce an electrical current or voltage pulse that corresponds to the optical pulse detected by the detection unit 306.

It is contemplated that, in various non-limiting embodiments of the present technology, the detection unit 306 may be implemented with one or more avalanche photodiodes (APDs), one or more single-photon avalanche diodes (SPADs), one or more PN photodiodes (e.g., a photodiode structure formed by a p-type semiconductor and a n-type semiconductor), one or more PIN photodiodes (e.g., a photodiode structure formed by an undoped intrinsic semiconductor region located between p-type and n-type regions), and the like.

In some non-limiting embodiments, the detection unit 306 may also include circuitry that performs signal amplification, sampling, filtering, signal conditioning, analog-to-digital conversion, time-to-digital conversion, pulse detection, threshold detection, rising-edge detection, falling-edge detection, and the like. For example, the detection unit 306 may include electronic components configured to convert a received photocurrent (e.g., a current produced by an APD in response to a received optical signal) into a voltage signal. The detection unit 306 may also include additional circuitry for producing an analog or digital output signal that corresponds to one or more characteristics (e.g., rising edge, falling edge, amplitude, duration, and the like) of a received optical pulse.

Depending on the implementation, the controller 310 may include one or more processors, an application-specific integrated circuit (ASIC), a field-programmable gate array (FPGA), and/or other suitable circuitry. The controller 310 may also include non-transitory computer-readable memory to store instructions executable by the controller 310 as well as data which the controller 310 may produce based on the signals acquired from other internal components of the LIDAR system 300 and/or may provide signals to the other internal components of the LIDAR system 300. The memory can include volatile (e.g., RAM) and/or non-volatile (e.g., flash memory, a hard disk) components. The controller 310 may be configured to generate data during operation and store it in the memory. For example, this data generated by the controller 310 may be indicative of the data points in the point cloud of the LIDAR system 300.

It is contemplated that, in at least some non-limiting embodiments of the present technology, the controller 310 could be implemented in a manner similar to that of implementing the electronic device 210 and/or the computer system 100, without departing from the scope of the present technology. In addition to collecting data from the detection unit 306, the controller 310 could also be configured to provide control signals to, and potentially receive diagnostics data from, the light source 302 and the scanning unit 308.

As previously stated, the controller 310 is communicatively coupled to the light source 302, the scanning unit 308, and the detection unit 306. In some non-limiting embodiments of the present technology, the controller 310 may be configured to receive electrical trigger pulses from the light source 302, where each electrical trigger pulse corresponds to the emission of an optical pulse by the light source 302. The controller 310 may further provide instructions, a control signal, and/or a trigger signal to the light source 302 indicating when the light source 302 is to produce optical pulses indicative, for example, of the output beam 314.

Just as an example, the controller 310 may be configured to send an electrical trigger signal that includes electrical pulses, so that the light source 302 emits an optical pulse, representable by the output beam 314, in response to each electrical pulse of the electrical trigger signal. It is also contemplated that the controller 310 may cause the light source 302 to adjust one or more characteristics of output beam 314 produced by the light source 302 such as, but not limited to: frequency, period, duration, pulse energy, peak power, average power, and wavelength of the optical pulses.

By the present technology, the controller 310 is configured to determine a “time-of-flight” value for an optical pulse in order to determine the distance between the LIDAR system 300 and one or more objects in the field of view, as will be described further below. The time of flight is based on timing information associated with (i) a first moment in time when a given optical pulse (for example, of the output beam 314) was emitted by the light source 302, and (ii) a second moment in time when a portion of the given optical pulse (for example, from the input beam 316) was detected or received by the detection unit 306. In some non-limiting embodiments of the present technology, the first moment may be indicative of a moment in time when the controller 310 emits a respective electrical pulse associated with the given optical pulse; and the second moment in time may be indicative of a moment in time when the controller 310 receives, from the detection unit 306, an electrical signal generated in response to receiving the portion of the given optical pulse from the input beam 316.

In other non-limiting embodiments of the present technology, where the beam splitting element 304 is configured to split the output beam 314 into the scanning beam (not depicted) and the reference beam (not depicted), the first moment in time may be a moment in time of receiving, from the detection unit 306, a first electrical signal generated in response to receiving a portion of the reference beam. Accordingly, in these embodiments, the second moment in time may be determined as the moment in time of receiving, by the controller 310 from the detection unit 306, a second electrical signal generated in response to receiving an other portion of the given optical pulse from the input beam 316.

By the present technology, the controller 310 is configured to determine, based on the first moment in time and the second moment in time, a time-of-flight value and/or a phase modulation value for the emitted pulse of the output beam 314. The time-of-light value T, in a sense, a “round-trip” time for the emitted pulse to travel from the LIDAR system 300 to the object 320 and back to the LIDAR system 300. The controller 310 is thus broadly configured to determine the distance 318 in accordance with the following equation:

$$D = \frac{c \cdot T}{2} , \qquad ( 1 )$$

wherein D is the distance 318, T is the time-of-flight value, and c is the speed of light (approximately 3.0×10⁸ m/s).

As previously alluded to, the LIDAR system 300 may be used to determine the distance 318 to one or more other potential objects located in the surroundings 250. By scanning the output beam 314 across the ROI 325 of the LIDAR system 300 in accordance with the predetermined scan pattern, the controller 310 is configured to map distances (similar to the distance 318) to respective data points within the ROI 325 of the LIDAR system 300. As a result, the controller 310 is generally configured to render these data points captured in succession (e.g., the point cloud) in a form of a multi-dimensional map. In some implementations, data related to the determined time of flight and/or distances to objects could be rendered in different informational formats.

As an example, this multi-dimensional map may be used by the electronic device 210 for detecting, or otherwise identifying, objects or determining a shape or distance of potential objects within the ROI 325 of the LIDAR system 300. It is contemplated that the LIDAR system 300 may be configured to repeatedly/iteratively capture and/or generate point clouds at any suitable rate for a given application.

It should be noted that such multi-dimensional maps may be recorded and stored as part of log data associated with the vehicle 220. As a result, point cloud data captured by LIDAR systems in a fleet of vehicles may be stored for later use. Furthermore, multi-dimensional maps captured by a given LIDAR system are used to localize the SDC during operation. How point cloud data captured by the LIDAR system during operation may be used for localizing the vehicle 220 will become apparent from the description herein further below.

### Autonomous Driving Processing Pipeline

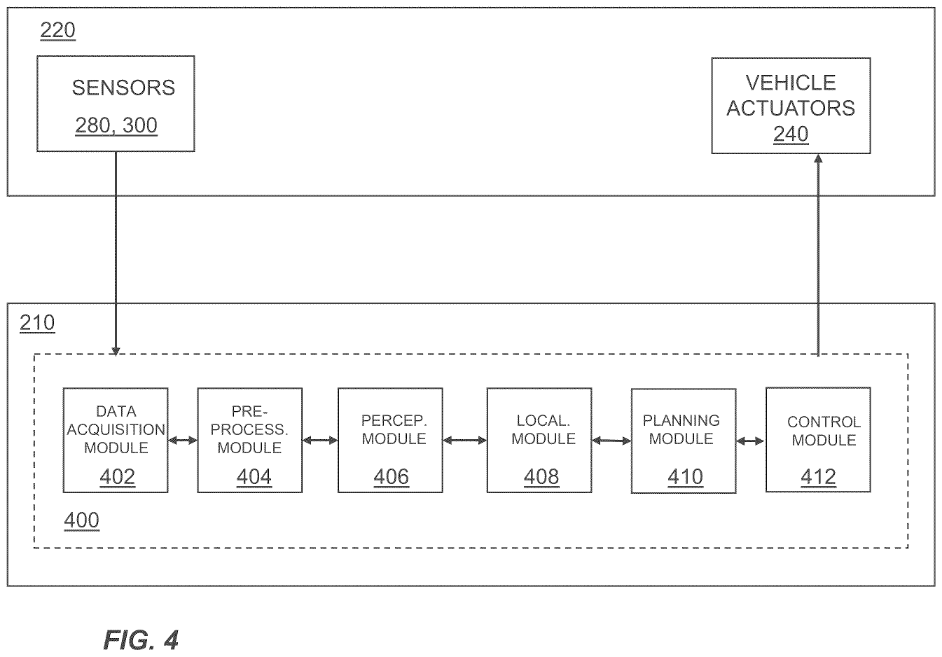

With reference to FIG. 4, there is depicted a schematic representation of a processing pipeline 400 executable by the electronic device 210 in at least some embodiments of the present technology. The electronic device 210 may be configured to execute the processing pipeline 400 for controlling operation of the vehicle 220 based on inter alia captured sensor data. It is contemplated that the processing pipeline 400 may be employed by the electronic device 210 in a cyclical manner.

Broadly speaking, a control cycle or loop of an autonomous vehicle represents a frequency at which the electronic device 210 processes sensor data, generates plans and/or trajectories, and sends commands to the actuators to adjust a vehicle's behavior. The electronic device 210 is configured to execute multiple control loops for continuously monitoring the vehicle's surroundings, making decisions, and executing actions to ensure safe and efficient operation. The duration of the control loop determines how quickly the vehicle can respond to changes in its surroundings and adjust its trajectory or speed accordingly. The processing periodicity of the control loop varies depending on the specific implementation of an autonomous vehicle system and its requirements. It can range from milliseconds to several tens of milliseconds, depending on factors such as the complexity of the surroundings, the speed of the vehicle 220, the desired level of responsiveness, and the like. A faster control loop, with a shorter processing periodicity, allows for more precise and agile control of the vehicle 220 but may require more computational resources. On the other hand, a slower control loop, with a longer processing periodicity, may be more computationally efficient but could result in less real-time responsiveness.

Broadly speaking, the processing pipeline 400 comprises a series of interconnected “modules” that analyze and interpret sensor data to enable real-time decision-making and control of the vehicle 220 in its surroundings. By integrating various sensor inputs and leveraging a plurality of algorithms, the processing pipeline 400 may be used for optimizing and/or controlling the vehicle's navigation, obstacle detection capabilities, and overall safety during operation. It should be noted that a “module” refers to a set of computer-implemented procedures executed by the electronic device 210 and which are aimed at addressing a set of related tasks in the context of autonomous driving. As such, it can be said that a given module may be implemented on the electronic device 210 as a set of computer-implemented instructions for causing the electronic device 210 to execute one or more functions associated with the set of related tasks.

The processing pipeline 400 comprises a data acquisition module 402 configured to acquire real-time data, where multiple sensors (e.g., cameras, lidar, radar, and the like) capture data about the surroundings. It is contemplated that the data acquisition module 402 may be communicatively coupled to one or more sensors of the vehicle 220, such as the LIDAR system 300 in FIG. 3, for example.

In this embodiment, the data acquisition model 402 is configured to provide at least some of the acquired data to a pre-processing module 404. Broadly speaking, the pre-processing module 404 may be configured to process acquired sensor data to remove noise, calibrate sensors, ensure data consistency, and the like. It is contemplated that one or more pre-processing techniques such as filtering, normalization, and synchronization, for example, may be used by the electronic device 210 to enhance the quality and/or reliability of sensor data to be used downstream in the processing pipeline 400.

In this embodiment, pre-processed data may be further provided to a perception module 406. Broadly speaking, the perception module 406 is configured to employ computer vision, machine learning, and a variety of sensor fusion techniques to extract meaningful information from the pre-processed and/or raw sensor data. The perception module 406 may be employed by the electronic device 210 for performing tasks such as object detection, object recognition, and object tracking, for example, for enabling the identification of vehicles, pedestrians, traffic signs, and other types of objects in the surroundings of the vehicle 220. It can be said that the perception module 406 may be configured to combine data from one or more sensors and generate a detailed representation of the surroundings of the vehicle 220. As it will be discussed below, the perception module 406 may generate bounding elements for respective objects detected in the surroundings.

In this embodiment, the processing pipeline 400 comprises a localization module 408. Broadly speaking, the localization module 408 is configured to determine a location and/or orientation of the vehicle 220 relative to other objects in the surroundings. It is contemplated that the localization module 408 may be configured to use a variety of localization techniques for determining the location and/or orientation of the vehicle 220 in the surroundings such as simultaneous localization and mapping (SLAM), global positioning system (GPS), and the like. It should be noted that a location and/or orientation of the vehicle 220 in the surroundings may be used downstream in the processing pipeline 400 for planning purposes, for example, allowing the electronic device 210 to make informed decisions regarding potential trajectories, paths, and maneuvers to be performed by the vehicle 220.

In this embodiment, the electronic device 210 is configured to employ a planning module 410 to plan motion of the vehicle 220 in its surroundings. Broadly speaking, the planning module 410 in the processing pipeline 400 is a combination of computer-implemented algorithms that are configured to analyze data acquired from other modules of the processing pipeline 400, generate planned trajectory data for operating the vehicle 220 based on the received data.

It can be said that the planning module 410 can update its decisions based on real-time sensor data and/or feedback from the control system of the vehicle 220. For example, the planning module 410 may update its decisions from one control cycle to another and dynamically adjust a planned trajectory to account for changing road conditions, unexpected obstacles, and/or changes in the surroundings.

It should be noted that the planning module 410 interfaces with inter alia the perception module 406 and the localization module 408. The planning module 410 may analyze perception data and localization data to make informed decisions based on the received data and generate trajectory data for the control module 412.

It is contemplated that the planning module 410 is configured to estimate distances between the vehicle 220 and objects in its surroundings for executing at least some planning tasks. A variety of planning tasks may require distance information for generating a trajectory for the vehicle 220.

In some embodiments, the planning module 410 may be configured to perform path planning for the vehicle 220. In these embodiments, the planning module 410 may generate a high-level route from the vehicle's 220 current location to the destination, considering factors like road network, traffic, and user preferences. In these embodiments, the planning module 410 may receive a global route as input and generate a trajectory, considering the surroundings of the SDC (including objects/obstacles), and vehicle dynamics. In these embodiments, the planning module 410 may perform lane changing planning by determining when and how to safely change lanes, considering factors such as traffic conditions, objects/obstacles, vehicle speed, and signaling.

In other embodiments, the planning module 410 may be configured to perform behavior planning for the vehicle 220 and/or other objects in the surroundings. In these other embodiments, the planning module 410 may analyze the current traffic situation, and traffic rules to perform real-time decisions, such as stopping at a red light, yielding to pedestrians, or merging into traffic. In these other embodiments, the planning module 410 may be configured to plan one or more maneuvers such as overtaking, parking, or negotiating intersections by considering the vehicle's capabilities and the surroundings (including objects/obstacles).

In further embodiments, the planning module 410 may be configured to perform motion planning for the vehicle 220. In these further embodiments, the planning module 410 may be configured to detect and avoid potential collisions with objects in the surroundings by computing safe and efficient trajectories. In these further embodiments, the planning module 410 may be configured to plan paths that circumvent static or dynamic objects in the surroundings while considering the vehicle's kinematic constraints. In these further embodiments, the planning module 410 may be configured to optimize the vehicle's trajectory over a specific time horizon to minimize energy consumption, discomfort to passengers, and/or other predefined criteria.

In this embodiment, the processing pipeline 400 comprises a control module 412 configured to use data generated by the planning module 410 to adjust the vehicle's actuators, including the steering, acceleration, and/or braking systems. For example, by continuously monitoring the vehicle's state and comparing it with the desired trajectory, the control module 412 may dynamically adjust the control signals, ensuring vehicle control in accordance with a planned trajectory and responsiveness to changing environmental conditions.

### Bird's Eye View (BEV)

Returning to the description of the perception module 406, the electronic device 210 is configured to use sensor data to generate a map representation of the surroundings 250 of the vehicle 220. In some embodiments, the perception module 406 may be configured to generate a BEV map representation of the surroundings 250. To that end, the perception module 406 may be configured to execute a computer-implemented method including a plurality of data processing steps.

The method begins with collecting sensor data from one or more of sensors mounted on the vehicle 220. For example, camera sensors may provide high-resolution images capturing the details of the surroundings, such as color and texture. LiDAR sensors are configured to emit laser beams to measure distances, thereby generating 3D representations of the surroundings 250. Radar sensors are configured to determine distance data and velocity data. Sensor data collected for generating BEV map representation may be combined to form a comprehensive input set for further processing by the perception module 406.

The method continues with integration or “fusion” of the sensor data. The electronic device 210 is configured to employ one or more sensor fusion techniques to generate a sensor-integrated representation of the surroundings 250. The sensor fusion techniques may be used to perform time and spatial alignment between datasets provided by different sensors and/or by sensors of different types. The sensor fusion techniques may enhance the overall accuracy and reliability of the data about the surroundings 250, and in a sense combines “strengths” of respective sensor data types, allowing generating an enriched representation of the surroundings 250. It should be noted that the sensor-fused data is a multi-dimensional dataset generated based on a combination of sensor data from a plurality of sensors of the vehicle 220.

The method continues with transformation from the sensor-fused data into a BEV image. In some cases, the electronic device 210 may be configured to project a 3D sensor-fused point cloud onto a 2D plane from a “top-down” perspective, effectively simulating a view from above the vehicle 220. In other cases, the electronic device 210 may be configured to perform homograph transformation on camera images to warp and adjust the images to fit the top-down perspective. It can be said that the projection operations executed during this step focus more on representing the layout of the surroundings 250 rather than its elevation.

It is contemplated that the BEV map may be enriched with additional data layers. Additional data layers may comprise information about static elements (such as roads, buildings, traffic signs, lane markings, and sidewalks, for example), and dynamic elements (such as moving vehicles and pedestrians, for example). Data in the additional data layers may be sourced by the electronic device 210 from a combination of GPS data, pre-stored maps, and real-time detection through advanced deep learning algorithms, without departing from the scope of the present technology.

In some embodiments, the electronic device 210 may be configured to continuously updated the BEV map during operation of the vehicle 220. Updating of the BEV map with new sensor data may be executed by the perception module 406 to reflect the latest changes in the surroundings 250, ensuring that the vehicle's understanding of its surroundings is current.

As it will become apparent from the description herein further below, the BEV map of the surroundings 250 may be employed by the electronic device 210 in a variety of ways. The BEV map is used by the perception module 406 to detect objects and obstacles in the surroundings 250. Also, the BEV map may be employed for navigation and path planning of the vehicle 220. For example, navigation algorithms may make use of the BEV map to calculate optimal driving paths that safely avoid obstacles while adhering to traffic regulations.

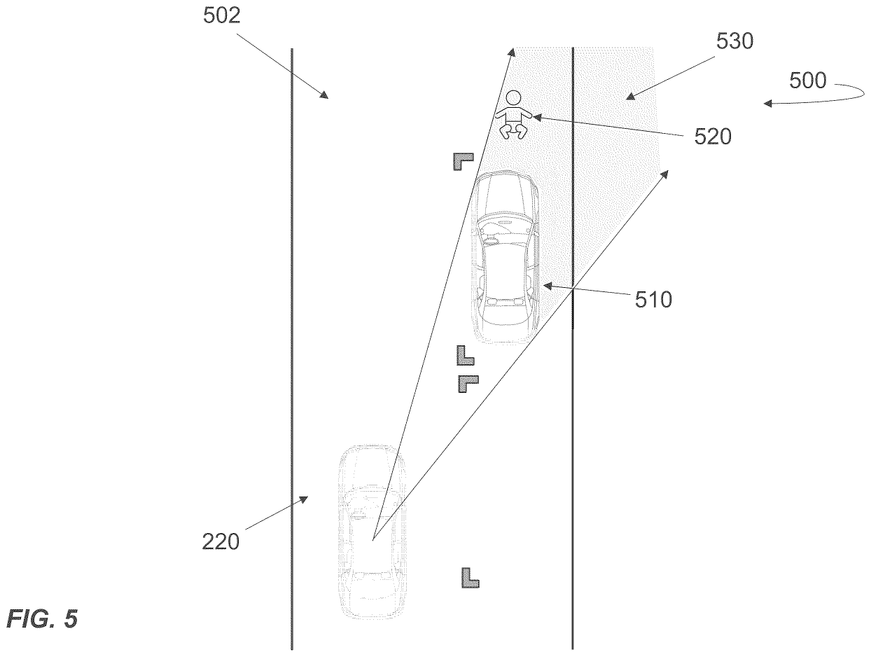

With reference to FIG. 5, there is depicted a BEV 500 of the surroundings 250 in a given non-limiting scenario. As seen from the top-down perspective, in this scenario the vehicle 220 is traveling on a road 502. There is also depicted a parked vehicle 510, and a pedestrian 520. In this scenario, it should be noted that due to the relative location of the vehicle 220 and of the parked vehicle 510, there is a “blind zone” 530 in the surroundings 250 corresponding to a zone that is obscured by the presence of the parked vehicle 510 from the one or more sensors of the vehicle 220.

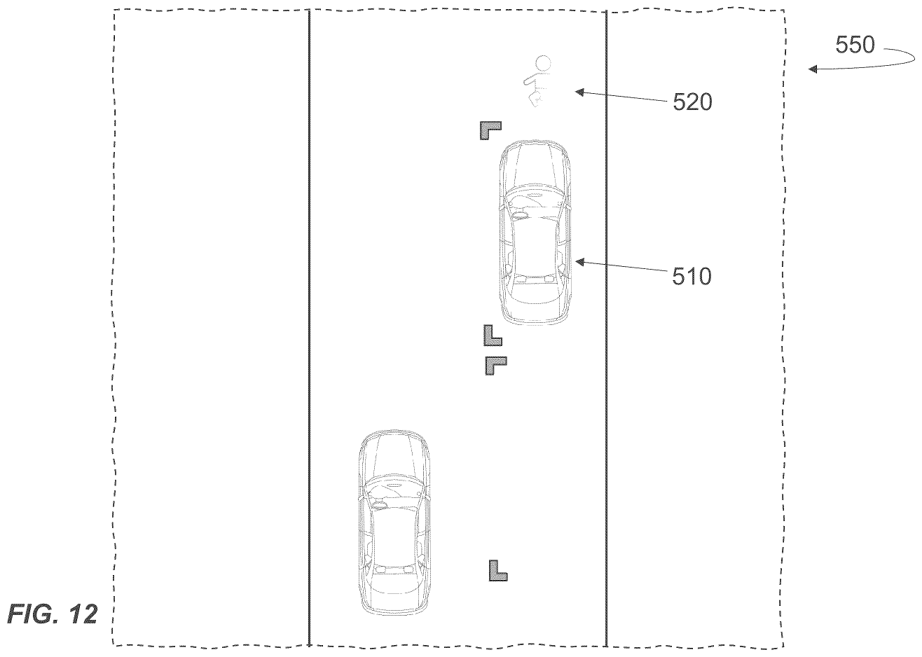

With reference to FIG. 12, there is depicted a schematic illustration of a BEV map 550 generated by the electronic device 210 based on sensor data in accordance with the scenario of FIG. 5. As it can be seen, the parked vehicle 510 is represented on the BEV map 550, however, the pedestrian 510 is relatively less well seen on the BEV map 550, at least partially due to the pedestrian 510 being located in the blind zone 530.

Developers of the present technology have realized that objects for which the perception module 406 has limited sensor data may not be well represented on BEV maps and are more difficult to detect. It should be noted that operating the vehicle 220 in the surroundings 250 where undetected objects are present may be detrimental to the safety of passengers and/or other actors in the environment, especially when the undetected objects are animate (such as moving vehicles, and pedestrians). As it will be described in greater details herein further below, developers have devised methods and processors for detecting objects in the surroundings 250, and also for identifying undetected objects potentially present in the surroundings 250.

### Logit Grid

The perception module 406 is configured to employ one or more machine learning algorithms onto the BEV map 550 in order to perform object detection. For example, the electronic device 210 may be configured to employ a Neural Network for performing object detection.

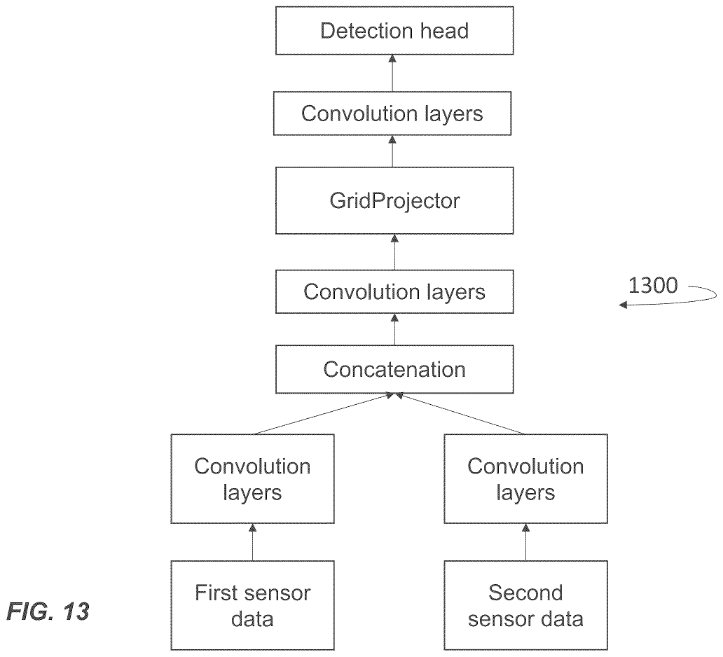

With a quick reference to FIG. 13, there is depicted a schematic illustration of a neural architecture 1300 employed by the perception module 406, in one non-limiting embodiment of the present technology. The neural architecture 1300 is configured to acquire lidar data input as first sensor data and camera data input as second sensor data for generating a given BEV map.

The first sensor data and the second sensor data can be used as an input for convolutional layers. In some not limiting embodiments, Residual Network blocks can be used as convolutional layers. The resulting feature maps of the first sensor data and the feature maps of the second sensor data are the output of the convolutional layers after processing the respective sensor data. It is contemplated that feature maps of the first sensor data and the feature maps of the second sensor data can be concatenated. The concatenated feature maps of the first and second sensor data can also be used as an input for next convolutional layers. The resulting concatenated feature maps can be used to generate a grid structure on the BEV map (intermediate representation of surroundings) by a Grid Projection operation. The generated grid structure on the BEV map is then can be used as an input for additional convolutional layers and then is used by a detection head network.

It can be said that a detector NN may acquire the sensor data and is configured to generate the BEV map. It should be noted that the detector NN is configured to generate a dense projection in a BEV. The detector NN is also configured to generate prediction values for respective cells of the so-generated BEV map. In one embodiment, the perception module 406 may be configured to use a Convolutional Neural Network (CNN) trained to generate a BEV map and predict objects on a BEV map.

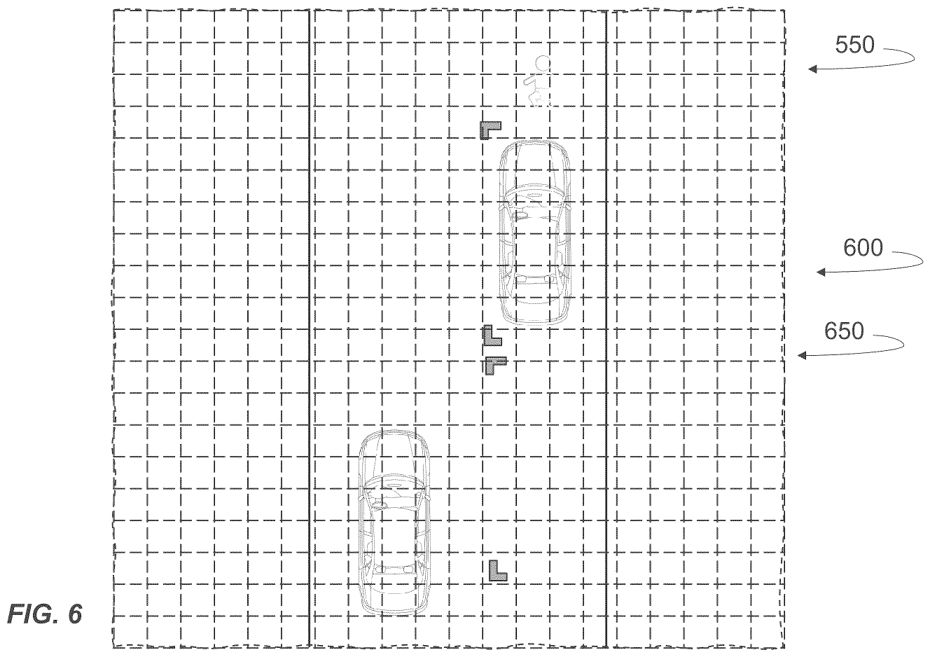

With reference to FIG. 6, there is depicted a grid structure 600 generated by the electronic device 210 based on the BEV map 550. The grid structure 600 comprises a plurality of cells 650 corresponding to respective portions of the BEV map 550. It can be said that a given cell from the plurality of cells 650 corresponds to one or more pixels of the BEV map 550. Data from the one or more pixels may be used to assess an occupancy status of the corresponding cell based on the fused sensor data in respective pixels.

The perception module 406 is configured to generate, using a “detection head” NN, a probability value for respective ones from the plurality of cells 650. A probability value is determined for a given cell based on data associated with respective pixels and is indicative of a likelihood that an object is present in the corresponding portion of the BEV map 550. In some embodiments, the probability value for a given cell may also depend on inter alia data associated with its neighboring cells and specific implementations of the present technology.

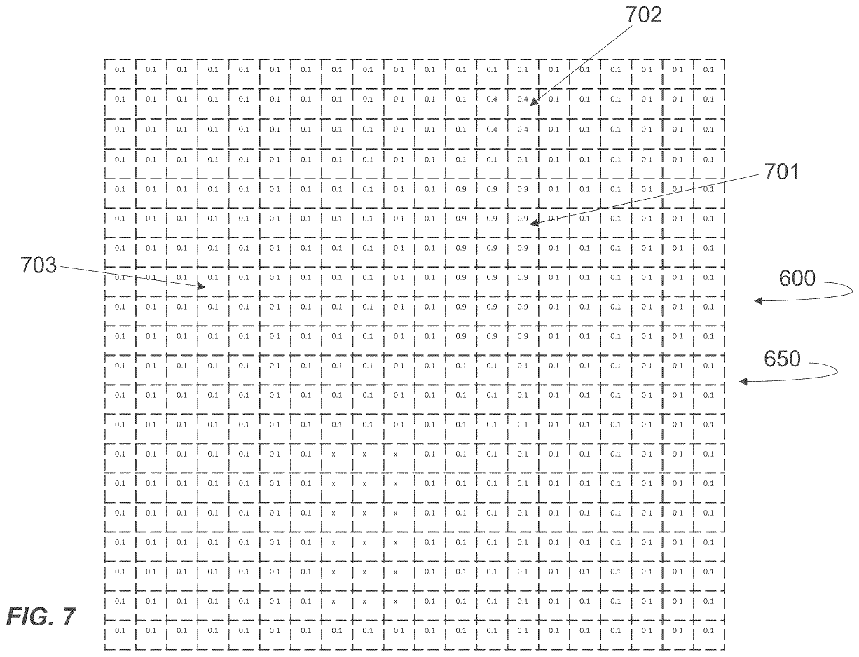

With reference to FIG. 7, there is depicted a plurality of probability values 700 computed for the plurality of cells 650 of the grid structure 600. For example, a first cell 701 is associated with a value of “0.9” and indicative of a likelihood of 90% that an object is present in the corresponding portion of the BEV map 550. In the same example, a second cell 702 is associated with a value of “0.4” and indicative of a likelihood of 40% that an object is present in the corresponding portion of the BEV map 550. In the same example, a third cell 703 is associated with a value of “0.1” and indicative of a likelihood of 10% that an object is present in the corresponding portion of the BEV map 550.

In one embodiment, the perception module 406 is configured to execute a bounding algorithm for generating one or more bounding shapes for objects detected in the BEV map 550. Generally speaking, a bounding algorithm is a computer-implemented procedure applicable on a 2D grid and involving a series of steps designed to interpret grid data effectively for identifying and delineating obstacles in an environment (i.e., performing object detection).

In some embodiments, the perception module 406 may be configured to apply a threshold analysis onto the logit grid to filter out cells with relatively low probability values for achieving a balance between precision and recall. Thus, cells with low probability values are filtered out for minimizing false positive indications of object(s).

In some embodiments, the perception module 406 may be configured to apply a threshold analysis onto the logit grid to identify cells with relatively high probability values for generating one or more bounding shapes, thereby detecting one or more objects. Additionally, noise reduction techniques such as morphological operations, including erosion and dilation, can be employed without departing from the scope of the present technology, to help in reducing noise and close small gaps in the data, and/or to aid in forming more coherent object shapes for subsequent analysis.

In some embodiments, the perception module 406 may be configured to perform cluster detection. For example, Connected Component Analysis (CCA) may be used to find and label groups of connected cells that are classified as “occupied”. This clustering can be based on either 4-connectivity, which considers up, down, left, and right connections, or 8-connectivity, which includes diagonals, allowing for more comprehensive component formation. In another example, Density-Based Spatial Clustering of Applications with Noise (DBSCAN) may be used to determine groups cells based on their density, facilitating the dynamic determination of clusters with or without the need to predefine the number of clusters (i.e., a potential optimization objective of the bounding algorithm).

In some embodiments, the perception module 406 may be configured to perform bounding shape fitting onto one or more clusters of cells. For example, the bounding shape algorithm may calculate minimum and maximum coordinates of the occupied cells within each cluster. These coordinates are then used to generate rectangular bounding boxes (and/or other bounding shapes) that encompass all the cells in the cluster. In other examples, the algorithm might also consider the orientation of the cluster, using techniques like Principal Component Analysis (PCA) to fit rotated bounding boxes (and/or other bounding shapes) that align more closely with the object's shape and orientation (i.e., a potential optimization objective of the bounding algorithm).

In some embodiments, the perception module 406 may be configured to perform a bounding shape optimization step. For example, bounding shapes that are too close or significantly overlap may be merged into a single box, and/or their boundaries can be adjusted to better fit the actual data (i.e., a potential optimization objective of the bounding algorithm). Conversely, large shapes that encompass multiple distinct objects might be split based on detected internal empty spaces within the cluster (i.e., a potential optimization objective of the bounding algorithm).

In one embodiment, the perception module 406 may use Non-Maximum Suppression (NMS) techniques for generating bounding shapes as it will be discussed in greater details below.

Additionally or alternatively, the dimensions of each bounding shape can be fine-tuned by the perception module 406 based on inter alia specific application requirements and/or additional sensor data in order to enhance the accuracy of the delineation, and without departing from the scope of the present technology.

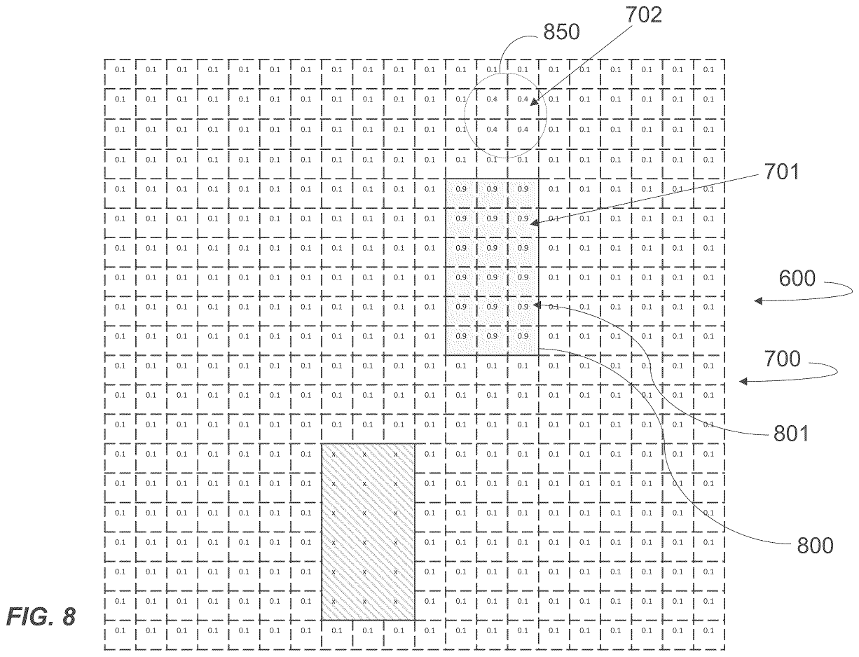

With reference to FIG. 8, there is depicted a bounding box 800 generated by the electronic device 210 for a first cluster of cells 801 including the first cell 701. In this example, the first cluster of cells 801 includes cells with probability values of “0.9”. It can be said that the first cluster of cells 801 is a bounded cluster of cells 801, and which is bounded by the bounding box 801. The bounded cluster of cells 801 is indicative of a presence of a detected object in the region of the BEV map 550 corresponding to the bounded cluster of cells 801. In this example, by generating the bounding box 800, it can be said that the perception module 406 detects the parked vehicle 510 on the portion of the BEV map 550 corresponding to the bounded cluster of cells 801.

In the same example, it should be noted that a second cluster of cells 850 including the second cell 702 are not bounced by a bounding shape. The second cluster of cells 850 includes cells with probability values of “0.4”. It can be said that the second cluster of cells 850 is a non-bounded cluster of cells 850. In this example, since the perception module 406 has not generated a bounding shape for the second cluster of cells 850, it can be said that the perception module 406 did not detect the pedestrian 520 on the portion of the BEV map 550 corresponding to the non-bounded cluster of cells 850.

Developers have realized that the pedestrian 520 may remain undetected by the perception module 406 for many different reasons.

In one example, the pedestrian 520 may remain undetected at least partially due to limited sensor data about the zone in which the pedestrian 520 is located, and which may result in comparatively lower probability values of cells in the second cluster of cells 850 than the probability values of cells in the first cluster of cells 801.

In another example, the pedestrian 520 may remain undetected at least partially due to one or more computer-implemented algorithms used during bounding shape generation. In one non-limiting example, the electronic device 210 may be configured to employ an NMS technique as part of the bounding algorithm for generating bounding shapes.

Broadly speaking, NMS is a technique designed to eliminate redundant or less relevant candidate bounding shapes. The objective of NMS is to identify and retain the most accurate bounding shape for a given object while suppressing all other candidate bounding shapes that are deemed unnecessary, thereby enhancing the precision of boundaries of detected objects. The NMS process begins with the assignment of scores to each candidate bounding shape. These scores, typically derived from an object detection model (such as a NN, for example), represent the confidence level or probability that an object is present within the respective candidate bounding shape. Following score assignment, the candidate bounding shapes are sorted in descending order based on their scores, ensuring that the candidate bounding shape with the highest confidence score is prioritized. Once sorted, the algorithm selects a candidate bounding shape with the highest score as a target bounding shape. Intersection over Union (IoU) between this target bounding shape and other remaining candidate bounding shapes can be computed. The IoU is a metric that quantifies the overlap between two bounding shapes. Any candidate bounding shapes that exhibit an IoU greater than a predefined threshold with the target bounding shape may thus be “suppressed”, meaning they are discarded as redundant detections of the same object. This selection and suppression process can be iteratively applied to the next highest score candidate bounding shape that has not been suppressed, continuing until all candidate bounding shapes have either been selected as target bounding shapes (actual bounding shapes generated for the grid structure) or otherwise suppressed (candidate bounding shapes that have been considered as potential options). The implementation of NMS may be used to ensure that each detected object is represented by a single, most confident bounding shape, thus reducing redundancy. NMS may improve the accuracy and reliability of boundaries of detected objects.

Application of NMS techniques may result in suppression of bounding shapes for objects that are actually present in the surroundings 250 of the vehicle 220. In this scenario, a candidate bounding shape may have been considered for the second cluster of cells 850, but once the electronic device 210 applies the NMS technique, this candidate bounding shape for the second cluster of cells 850 may be suppressed and resulting in the second cluster of cells 850 not being bounded by a corresponding bounding shape for further processing.

Developers of the present technology have realized that the use of NMS techniques in the context of autonomous driving applications may result in a trade-off between (i) improved accuracy and reliability of boundaries of detected objects and (ii) safe operation of the vehicle 220 due to potential suppression of bounding shapes for other objects in the surroundings which therefore remain undetected.

Irrespective of a specific reason for a given object remaining undetected by the object detection module, developers of the present technology have devised methods and processors for leveraging probability values of non-bounded cells for a safer operation of the vehicle 220 in an environment that has undetected objects present therein.

In this scenario, it can be said that the first cell 701 is a “top-tier” cell of the grid structure 600 with a relatively high probability value. Top-tier cells are cells with relatively high probability values that have been bounded and correspond to detected objects. In contrast, it can be said that the third cell 703 is a “bottom-tier” cell of the grid structure 600 with a relatively low probability value. Bottom-tier cells are cells with relatively low probability values that have not been bounded and do not correspond to detected objects.

Similarly to the third cell 703 and in contrast to the first cell 701, the second cell 702 has not been bounded and does not correspond to a detected object. However, it can be said that the second cell 702 is a “mid-tier” cell of the grid structure 600 with a comparatively higher probability value than the probability value of the third cell 703, but yet remains not bounded. Mid-tier cells are cells with relatively high probability values that have not been bounded and do not correspond to detected objects.

Developers of the present technology have devised methods and processors for leveraging probability values of mid-tier cells of the grid structure 600 for controlling operation of the vehicle 220. In at least some embodiments of the present technology, the electronic device 210 may be configured to (i) trigger control of the vehicle 220 in the surroundings 250 based on the presence of detected objects corresponding to top-tier cells of the grid structure 600, and (ii) trigger control of the vehicle 220 in the surroundings 250 based on the potential presence of undetected objects corresponding to mid-tier cells of the grid structure 600. In at least one embodiment, the electronic device 210 may be configured to trigger one or more control actions based on the presence of detected objects corresponding to top-tier cells of the grid structure 600, and independently trigger one or more additional control actions based on the potential presence of undetected objects corresponding to mid-tier cells of the grid structure 600. How the electronic device 210 is configured to classify cells of the grid structure 600 and/or differentiate between top-tier cells, mid-tier cells, and bottom-tier cells of the grid structure 600 will now be described in greater details.

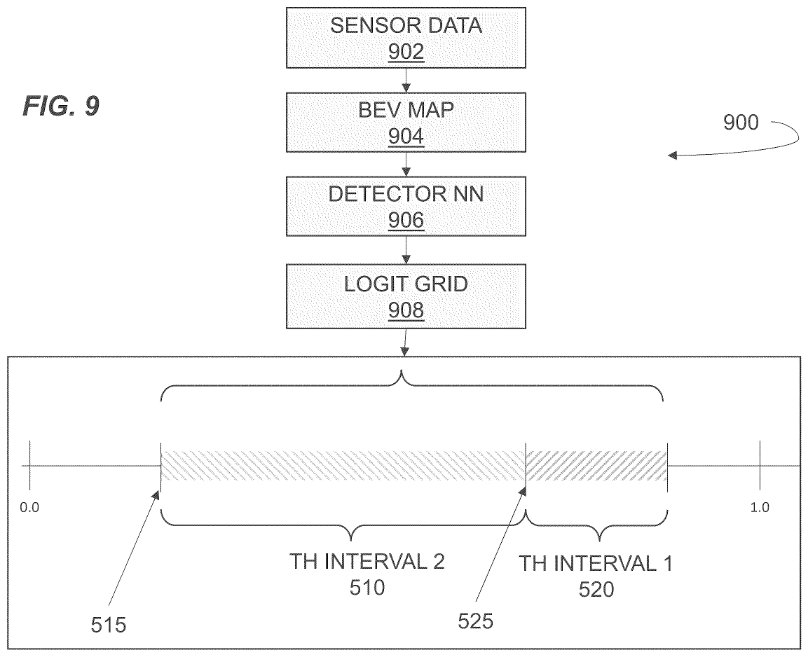

With reference to FIG. 9, there is depicted a representation of a processing pipeline 900 executed by the electronic device 210, in accordance with a first embodiment of the present technology. The electronic device 210 is configured to acquire sensor data 902 from one or more sensors of the vehicle 220. In some embodiments, the sensor data may comprise one or more 3D point clouds generated by one or more LIDAR systems, and one or more 2D images generated by one or more camera systems.

The electronic device 210 is configured to generate a BEV map 904 of the surroundings 250 of the vehicle 220, similarly to how the electronic device 210 is configured to generate the BEV map 550, for example. In some embodiments, the electronic device 210 may employ one or more sensor-fusion techniques in order to combine information from different sensor sources and perform a projection of the combined data into a 2D representation of the surroundings 250 from a top-down perspective.

The electronic device 210 is configured to provide the BEV map 904 to a detection NN 906. The detection NN 906 is configured to generate a logit grid 908 with a grid structure and a plurality of cells.

Broadly, a given logit grid may comprise information indicative of probabilities of whether object(s) are present within respective cells. It is contemplated that logit grids may be generated in the context of machine learning techniques using different non-normalized probability distribution(s). Developers have realized that the given logit grid may be configured to assess probability values prior to an activation step being applied.

In this first embodiment, the electronic device 210 may be configured to employ a detection threshold 525 for identifying top-tier cells. In this first embodiment, the detection threshold 525 represents a minimum probability value that a given cell may need to be considered by the perception module 406 as corresponding to a detected object. For example, in response to the probability value of a given cell from the logit grid 908 being above the detection threshold 525, the electronic device 210 is configured to generate a bounding shape covering the given cell and/or classify the given cell as a top-tier cell.

In this first embodiment, the electronic device 210 may be configured to employ a safety threshold 515 for identifying mid-tier cells. In this first embodiment, the safety threshold 515 represents a minimum probability value that a given cell may need to be considered by the perception module 406 as corresponding to an undetected object potentially present in the surroundings 250. For example, in response to the probability value of a given cell from the logit grid 908 being above the detection threshold 515 and below the detection threshold 525, the electronic device 210 is configured to classify the given cell as a mid-tier cell.

In response to detecting one or more objects in the surroundings 250 (generating bounding shapes and/or classifying some cells as top-tier cells), the electronic device 210 is configured to perform path planning for the vehicle 220 through the surroundings 250 while taking into account the presence of the detected objects, and trigger one or more actions for controlling operation of the vehicle 220 in accordance with the planned path.

In response to the determining that one or more undetected objects are potentially present in the surroundings 250 (classifying one or more cells as mid-tier cells), the electronic device 210 may trigger the SDC to perform a remedial action. For example, the electronic device 210 may trigger one or more actions for reducing speed of the vehicle 220. It is contemplated that this remedial action can be triggered independently from other actions triggerable by the electronic device 210 based on the detected objects. In this example, the electronic device 210 may be configured to trigger one or more actions for reducing speed of the vehicle 220 independently from path planning operations and one or more actions triggered for controlling operation of the vehicle 220 in accordance with the planned path.

In a second embodiment of the present technology, developers have devised a methods and processors for executing a two two-stage object detection process. During the first stage, the electronic device 210 may generate the bounding box 850 covering the first cell 701 from the plurality of cells 700 using a bounding technique and based on at least the first probability value of the first cell 701. The bounding box 800 is indicative of that a detected object is present in a first portion of the BEV map 550 (in this case, the parked vehicle 510).

In this second embodiment, during the second stage, the electronic device 210 is configured to process the probability values of the plurality of cells 700, in parallel or sequentially to the first stage, to determine that an undetected object (in this case, the pedestrian 520) is potentially present in a second portion of the BEV map 550 based on at least the probability value of the second cell 702.

In some embodiments, during the second stage, when performed sequentially to the first stage, the electronic device 210 may be configured to identify non-bounded cells of the grid structure by excluding cells bounded by bounding shapes generated during the first stage. Then, the remaining non-bounded cells may be classified as mid-tier cells and bottom-tier cells using the safety threshold 515. In other embodiments, during the second stage, when performed in parallel to the first stage, the electronic device 210 may be configured to identify mid-tier cells using the detection threshold 525 and the safety threshold 515.

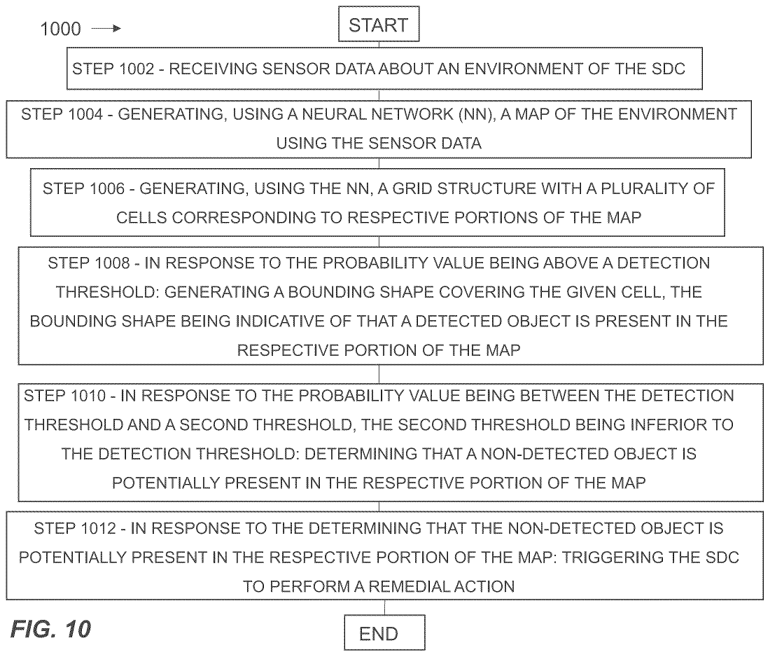

With reference to FIG. 10, there is depicted a flow-chart of a method 1000 executable by the electronic device 210 in accordance with certain non-limiting embodiments of the present technology. Various steps of the method 1000 will now be described.

STEP 1002: Receiving Sensor Data about an Environment of the SDC

The method 1000 begins at step 1002 with the electronic device 210 configured to receive data from sensors mounted on the vehicle 220 about an environment 250 of the SDC.

In some embodiments, the electronic device 210 may be configured to receive data from a LIDAR system 300 that may function as a sensor and create a 3D point cloud that represents the shape, size, and location of the objects in the environment. For example, the LIDAR system 300 may make use of a predetermined scan pattern to generate a point cloud substantially covering the ROI 325 of the LIDAR system 300.

In some embodiments, the electronic device 210 may be configured to employ one or more sensor fusion techniques to generate a sensor-integrated representation of the surroundings 250.

### STEP 1004: Generating, Using a Neural Network (NN), a Map of the Environment Using the Sensor Data

The method 1000 continues to step 1004 with the electronic device 210 configured to generate, using a Neural Network (NN), a map of the environment using the sensor data.

In some embodiments, the electronic device 210 may be configured to use the sensor data from STEP 1002 to generate a map representation of the surroundings 250 of the vehicle 220.

For example, the electronic device 210 may make use of the perception module 406 configured to generate a BEV map representation 550 of the surroundings 250. To that end, the perception module 406 may be configured to execute a computer-implemented method including a plurality of data processing steps.

STEP 1006: Generating, Using the NN, a Grid Structure with a Plurality of Cells Corresponding to Respective Portions of the Map

The method 1000 continues to step 1006 with the electronic device 210 configured to generate, using the NN, a grid structure with a plurality of cells corresponding to respective portions of the map, a given cell from the plurality of cells being associated with a probability value indicative of a probability that an object is present in the respective portion of the map.

For example, the electronic device 210 may make use of the perception module 406 configured to employ the neural architecture 1300 onto the BEV map 550 in order to generate the grid structure 600 based on the BEV map 550. Furthermore, the electronic device 210 may make use of the perception module 406 configured to generate, using a “detection head” NN, a probability value for respective ones from the plurality of cells 650 of the grid structure 600.

STEP 1008: In Response to the Probability Value being Above a Detection Threshold: Generating a Bounding Shape Covering the Given Cell, the Bounding Shape being Indicative of that a Detected Object is Present in the Respective Portion of the Map

The method 1000 continues to step 1008 with the electronic device 210 configured to generate, in response to the probability value being above a detection threshold 525, a bounding shape covering the given cell, the bounding shape being indicative of that a detected object is present in the respective portion of the map.

In some embodiments, the electronic device 210 may make use of the perception module 406 configured to execute a bounding algorithm for generating one or more bounding shapes for objects detected in the BEV map 550.

In some embodiments, the bounding shape may be a bounding box.

STEP 1010: In Response to the Probability Value being Between the Detection Threshold and a Second Threshold, the Second Threshold being Inferior to the Detection Threshold: Determining that an Undetected Object is Potentially Present in the Respective Portion of the Map

The method 1000 continues to step 1010 with the electronic device 210 configured to determine, in response to the probability value being between the detection threshold 525 and a second threshold 515, the second threshold 515 being inferior to the detection threshold 525, that an undetected object is potentially present in the respective portion of the map.

For example, in response to the probability value of a given cell from the logit grid 908 being above the detection threshold 515 and below the detection threshold 525, the electronic device 210 may be configured to determine that an undetected object is potentially present that cell.

STEP 1012: In Response to the Determining that the Undetected Object is Potentially Present in the Respective Portion of the Map: Triggering the SDC to Perform a Remedial Action

The method 1000 continues to step 1012 with the electronic device 210 configured to trigger the SDC to perform a remedial action, in response to the determining that the undetected object is potentially present in the respective portion of the map.

For example, the electronic device 210 may trigger one or more actions for reducing speed of the vehicle 220.

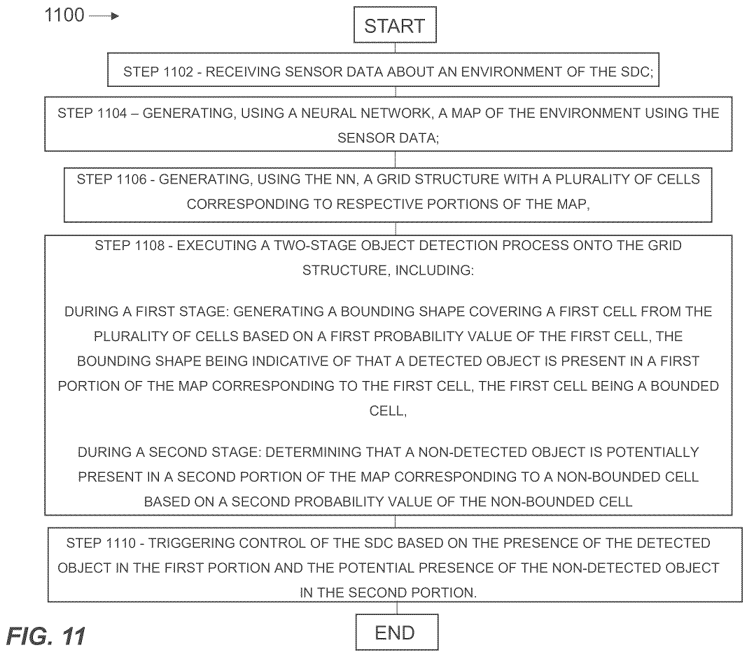

With reference to FIG. 11, there is depicted a flow-chart of a method 1100 executable by the electronic device 210 in accordance with certain non-limiting embodiments of the present technology. Various steps of the method 1100 will now be described.

STEP 1102: Receiving Sensor Data about an Environment of the SDC

The method 1100 begins at step 1102 with the electronic device 210 configured to receive sensor data about an environment of the SDC.

In some embodiments, the electronic device 210 may be configured to receive data from a LIDAR system 300 that may function as a sensor and create a 3D point cloud that represents the shape, size, and location of the objects in the environment. For example, the LIDAR system 300 may make use of a predetermined scan pattern to generate a point cloud substantially covering the ROI 325 of the LIDAR system 300.

In some embodiments, the electronic device 210 may be configured to employ one or more sensor fusion techniques to generate a sensor-integrated representation of the surroundings 250.

### STEP 1104: Generating, Using a Neural Network (NN) a Map of the Environment Using the Sensor Data

The method 1100 continues to step 1104 with the electronic device 210 configured to generate, using a Neural Network (NN) a map of the environment using the sensor data.

In some embodiments, the electronic device 210 may be configured to use the sensor data from STEP 1102 to generate a map representation of the surroundings 250 of the vehicle 220.

For example, the electronic device 210 may make use of the perception module 406 configured to generate a BEV map representation 550 of the surroundings 250. To that end, the perception module 406 may be configured to execute a computer-implemented method including a plurality of data processing steps.

STEP 1106: Generating, Using the NN, a Grid Structure with a Plurality of Cells Corresponding to Respective Portions of the Map

The method 1100 continues to step 1106 with the electronic device 210 configured to generate, using the NN, a grid structure with a plurality of cells corresponding to respective portions of the map, a given cell from the plurality of cells being associated with a probability value indicative of a probability that an object is present in the respective portions of the map.

For example, the electronic device 210 may make use of the perception module 406 configured to employ the neural architecture 1300 onto the BEV map 550 in order to generate the grid structure 600 based on the BEV map 550. Furthermore, the electronic device 210 may make use of the perception module 406 configured to generate, using a “detection head” NN, a probability value for respective ones from the plurality of cells 650 of the grid structure 600.

STEP 1108: Executing a Two-Stage Object Detection Process onto the Grid Structure, Including: During a First Stage: Generating a Bounding Shape Covering a First Cell from the Plurality of Cells Based on a First Probability Value of the First Cell, the Bounding Shape being Indicative Of that a Detected Object is Present in a First Portion of the Map Corresponding to the First Cell, the First Cell being a Bounded Cell, During a Second Stage: Determining that a Undetected Object is Potentially Present in a Second Portion of the Map Corresponding to a Non-Bounded Cell Based on a Second Probability Value of the Non-Bounded Cell

The method 1100 continues to step 1106 with the electronic device 210 configured to execute a two-stage object detection process onto the grid structure, including: during a first stage: generate a bounding shape covering a first cell from the plurality of cells based on a first probability value of the first cell, the bounding shape being indicative of that a detected object is present in a first portion of the map corresponding to the first cell, the first cell being a bounded cell, during a second stage: determine that an undetected object is potentially present in a second portion of the map corresponding to a non-bounded cell based on a second probability value of the non-bounded cell.

In some embodiments, during the first stage, the electronic device 210 may generate the bounding box 850 covering the first cell 701 from the plurality of cells 700 using a bounding technique and based on at least the first probability value of the first cell 701. The bounding box 800 is indicative of that a detected object is present in a first portion of the BEV map 550 (in this case, the parked vehicle 510).

In some embodiments, during the second stage, the electronic device 210 may be configured to process the probability values of the plurality of cells 700, in parallel or sequentially to the first stage, to determine that an undetected object (for example, the pedestrian 520) is potentially present in a second portion of the BEV map 550 based on at least the probability value of the second cell 702.

In some embodiments, during the second stage, when performed sequentially to the first stage, the electronic device 210 may be configured to identify non-bounded cells of the grid structure by excluding cells bounded by bounding shapes generated during the first stage. Then, the remaining non-bounded cells may be classified as mid-tier cells and bottom-tier cells using the safety threshold 515.

In other embodiments, during the second stage, when performed in parallel to the first stage, the electronic device 210 may be configured to identify mid-tier cells using the detection threshold 525 and the safety threshold 515.

In some embodiments, the bounding shape may be a bounding box.

### STEP 1110: Triggering Control of the SDC Based on the Presence of the Detected Object in the First Portion and the Potential Presence of the Undetected Object in the Second Portion

The method 1100 continues to step 1110 with the electronic device 210 configured to trigger control of the SDC based on the presence of the detected object in the first portion and the potential presence of the undetected object in the second portion.

For example, the electronic device 210 may trigger one or more actions for reducing speed of the vehicle 220.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of controlling operation of a self-driving car (SDC), the method including:
receiving sensor data about an environment of the SDC;
generating, using a Neural Network (NN), a map of the environment using the sensor data;
generating, using the NN, a grid structure with a plurality of cells corresponding to respective portions of the map,
a given cell from the plurality of cells being associated with a probability value indicative of a probability that an object is present in the respective portion of the map;
in response to the probability value being above a detection threshold:
generating a bounding shape covering the given cell, the bounding shape being indicative of that a detected object is present in the respective portion of the map;
in response to the probability value being between the detection threshold and a second threshold, the second threshold being inferior to the detection threshold:
determining that an undetected object is potentially present in the respective portion of the map; and
in response to the determining that the undetected object is potentially present in the respective portion of the map:
triggering the SDC to perform a remedial action.

2. The method of claim 1, wherein the sensor data comprises first sensor data from a first sensor, and second sensor data from a second sensor.

3. The method of claim 2, wherein the first sensor data is a point cloud and the first sensor is a LIDAR sensor.

4. The method of claim 2, wherein the method further comprises generating fused sensor data by combining the first sensor data and the second sensor data, and wherein the generating the map of the environment comprises generating the map of the environment using the fused sensor data.

5. The method of claim 1, wherein the map of the environment is a Bird Eye View (BEV) map of the environment.

6. The method of claim 1, wherein the bounding shape is a bounding box.

7. The method of claim 1, wherein the remedial action is a reduction of speed of the SDC.

8. The method of claim 1, wherein the triggering the SDC to perform the remedial action is executed independently from one or more path planning operations.

9. The method of claim 1, wherein the generating the bounding shape comprises executing a Non-Maximum Suppression (NMS) algorithm onto a plurality of candidate bounding shapes.

10. A method of controlling operation of a self-driving car (SDC), the method including:
receiving sensor data about an environment of the SDC;
generating, using a Neural Network, a map of the environment using the sensor data;
generating, using the NN, a grid structure with a plurality of cells corresponding to respective portions of the map,
the plurality of cells being associated with respective probability values indicative of a probability that an object is present in the respective portions of the map;
executing a two-stage object detection process onto the grid structure, including:
during a first stage:
generating a bounding shape covering a first cell from the plurality of cells based on a first probability value of the first cell, the bounding shape being indicative of that a detected object is present in a first portion of the map corresponding to the first cell, the first cell being a bounded cell;
during a second stage:
determining that an undetected object is potentially present in a second portion of the map corresponding to a non-bounded cell based on a second probability value of the non-bounded cell;
triggering control of the SDC based on the presence of the detected object in the first portion and the potential presence of the undetected object in the second portion.

11. An electronic device for controlling operation of a self-driving car (SDC), the electronic device being configured to:
receive sensor data about an environment of the SDC;
generate, using a Neural Network (NN), a map of the environment using the sensor data;
generate, using the NN, a grid structure with a plurality of cells corresponding to respective portions of the map,
a given cell from the plurality of cells being associated with a probability value indicative of a probability that an object is present in the respective portion of the map;
in response to the probability value being above a detection threshold:
generate a bounding shape covering the given cell, the bounding shape being indicative of that a detected object is present in the respective portion of the map;
in response to the probability value being between the detection threshold and a second threshold, the second threshold being inferior to the detection threshold:
determine that an undetected object is potentially present in the respective portion of the map; and
in response to determining that the undetected object is potentially present in the respective portion of the map:
trigger the SDC to perform a remedial action.

12. The electronic device of claim 11, wherein the sensor data comprises first sensor data from a first sensor, and second sensor data from a second sensor.

13. The electronic device of claim 12, wherein the first sensor data is a point cloud and the first sensor is a LIDAR sensor.

14. The electronic device of claim 12, wherein the electronic device is further configured to generate fused sensor data by combining the first sensor data and the second sensor data, and wherein to generating the map of the environment comprises the electronic device configured to generate the map of the environment using the fused sensor data.

15. The electronic device of claim 11, wherein the map of the environment is a Bird Eye View (BEV) map of the environment.

16. The electronic device of claim 11, wherein the bounding shape is a bounding box.

17. The electronic device of claim 11, wherein the remedial action is a reduction of speed of the SDC.

18. The electronic device of claim 11, wherein to trigger the SDC to perform the remedial action comprises the electronic device to perform the remedial action independently from one or more path planning operations.

19. The electronic device of claim 11, wherein to generating the bounding shape comprises the electronic device configured to execute a Non-Maximum Suppression (NMS) algorithm onto a plurality of candidate bounding shapes.

20. The electronic device of claim 11, wherein the electronic device is a local electronic device of the SDC.
